(19) United States
(12) Patent Application Publication
(10) Pub. No.: US 2026/0288924 A1
(43) Pub. Date: Sep. 24, 2026

(54) HUMAN-IN-LOOP MACHINE LEARNING SYSTEM FOR IDENTITY VERIFICATION USING ADAPTABLE AND DISPARATE SAMPLING TECHNIQUES

(71) Applicant: Onfido Ltd, London (GB)

(72) Inventors: Daniel Serrano, Lisbon (PT); Filipe Morais, Lisbon (PT); Lukasz Dziekan, Berlin (DE); João Serra, Amadora (PT); Sérgio Boer, Ançã (PT)

(21) Appl. No.: 19/573,548

(22) Filed: Mar. 20, 2026

Related U.S. Application Data
(60) Provisional application No. 63/775,789, filed on Mar. 21, 2025.

(51) Int. Cl. G06F 21/32

(52) U.S. Cl. CPC G06F 21/32

(57) ABSTRACT

Methods and systems for sampling and analyzing identity verification data for potential fraud include obtaining samples from authentication cases analyzed by an authentication model using a plurality of sampling techniques. In some examples, the sampling techniques may be configurable. The samples may be provided for manual review, and the results of the manual review process may be used to update the authentication model. Additionally, in some examples, sampling statistics may be calculated based on the results of the manual review process. The sampling statistics and user defined constraints may be used to automatically configured the sampling techniques. Further, in some examples, iterative sampling based on the manual review results may be used to select additional samples for manual review.

### CROSS-REFERENCE TO RELATED APPLICATIONS

This application claims priority to U.S. Provisional Patent Application No. 63/775,789 filed Mar. 21, 2025, the disclosure of which is incorporated herein by reference in its entirety.

### BACKGROUND

Access to secure resources may often be controlled through use of authentication services. Such authentication services may require identity verification (e.g., validating the identity of a user) and authentication (e.g., authentication of the user who is associated with the identity, and validating their right to access the secure resources). Such services, referred to collectively herein as authentication services, or authentication generally, allow customers to protect secure resources by requiring a user who wishes to access the secure resources to verify his/her identity. From a user perspective, this may include providing identification and/or liveness information to indicate that (1) the user is who they say they are, and (2) the user is in fact present (e.g., rather than being substituted by a photograph, image, or three-dimensional representation of that user who may not therefore be present at the time of identity verification).

In this context, authentication models, such as identity verification and/or liveness models, may be used to perform respective identity verification and/or liveness assessments. Authentication may include presenting biometric information of a user, which may be compared to existing or pre-registered information to verify that user's identity, and/or may be classified regarding liveness, using the authentication models. Malicious actors often attempt to manipulate such authentication services, e.g., to obtain a positive authentication result through deception. To prevent malicious actors from deceiving the authentication models, the authentication services may update their models to prevent new and emerging types of fraud attempted by such actors.

In most circumstances, fraud may make up a very small percentage of cases. In an example, fraud may occur in approximately 0.2% of cases. Further, unidentified fraud may occur even less frequently. In an example, unidentified fraud may occur in approximately 0.01-0.02% of cases. Cases of fraud are therefore both sparse and intermixed with legitimate uses of authentication services. As such, it may be difficult for authentication services to quickly identify new cases of fraud with which the authentication models can be trained.

### SUMMARY

In accordance with aspects of the present disclosure, adaptable and disparate techniques for sampling identity verification data sampling potential fraud cases for manual review is provided. In example embodiments, samples from production data are selected and submitted for manual review. One or more sampling techniques may be used to select the samples, and the sampling techniques may be configurable. Examples of sampling techniques include random sampling, rejection sampling, uncertainty sampling, and diversity sampling. The results of the manual review process may be used to update authentication models.

In a first aspect, a method for training an identity verification authentication model configured to detect fraudulent authentication attempts from biometric data is provided. A plurality of authentication cases is analyzed using an authentication model. Each authentication case comprises biometric content captured during an identity verification attempt. A plurality of samples is selected from the plurality of authentication cases using a plurality of sampling techniques. A plurality of labeling tasks is transmitted to one or more administrators for manual review. Each labeling task is associated with a sample of the plurality of samples. Manual review results are received for the plurality of labeling tasks. Each manual review result indicates whether the associated sample is legitimate or fraudulent. One or more cluster patterns in an embedding space are identified based on the manual review results. Authentication cases corresponding to known fraudulent attempts form fraudulent clusters and authentication cases corresponding to legitimate attempts form legitimate clusters. The authentication model is updated based on the manual review results and the identified cluster patterns to improve detection of both known fraud patterns within existing clusters and emerging fraud patterns represented by outlier cases distant from known fraudulent clusters.

In a second aspect, a system for automating sampling of authentication case data in an identity verification system is provided. The system includes a processing unit and a memory. The memory stores instructions which, when executed, cause the system to perform actions including receiving a dataset comprising (1) biometric data previously submitted to an identity verification system for analysis at an authentication model during an identity verification attempt and (2) results of the analysis at the authentication model. The actions further include analyzing the dataset to identify a plurality of samples using a plurality of sampling techniques, identifying one or more cluster patterns in an embedding space based on a manual review of the plurality of samples, and in response identifying the one or more cluster patterns, automatically identifying one or more additional samples from among the dataset, the one or more additional samples being proximate in the embedding space to a sample associated with a fraudulent cluster. Authentication cases corresponding to known fraudulent attempts form fraudulent clusters and authentication cases corresponding to legitimate attempts form legitimate clusters. The actions further include training an updated authentication model based, at least in part, on the manual review of the plurality of samples, the one or more cluster patterns, and the one or more additional samples to improve detection of both known fraud patterns within existing clusters and emerging fraud patterns represented by outlier cases distant from known fraudulent cluster.

In a third aspect, a method for configuring sampling techniques for selecting samples for training an authentication model configured to detect fraudulent authentication attempts from biometric data is provided. Configuration information is received defining a configuration of each of a plurality of sampling techniques. A plurality of authentication cases is analyzed using an authentication model. Each authentication case comprises biometric content captured during an identity verification attempt. A plurality of samples is selected from the plurality of authentication cases using a plurality of sampling techniques. A number of samples collected by each of the one or more sampling techniques is defined by a configuration of the sampling technique. A plurality of labeling tasks is transmitted to one or more administrators for manual review. Each labeling task is associated with a sample of the plurality of samples. Manual review results are received for the plurality of labeling tasks. Each manual review result indicates whether the associated sample is legitimate or fraudulent. One or more sampling statistics are calculated for each of the plurality of sampling techniques. Based on the sampling statistics and one or more defined restraints, the configurations of the one or more sampling techniques are modified.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment for authenticating users.

FIG. 2 illustrates a flowchart of a method for identifying cases of fraud and using the identified cases to train authentication models.

FIG. 3 illustrates an embodiment of an authentication server.

FIG. 4 illustrates a detailed view of the authentication server for conducting a manual review process.

FIG. 5 illustrates an example of random sampling.

FIG. 6 illustrates an example of rejection sampling.

FIG. 7 illustrates an example of uncertainty sampling.

FIG. 8 illustrates another example of uncertainty sampling.

FIG. 9 illustrates another example of uncertainty sampling.

FIG. 10 illustrates an example of diversity sampling.

FIG. 11 illustrates a visualization of clusters of authentication cases.

FIG. 12 illustrates a flowchart of a method for selecting samples for a manual review process using diversity sampling.

FIG. 13 illustrates an example of iterative sampling.

FIG. 14 illustrates a flowchart of a method for performing iterative sampling.

FIG. 15 illustrates a labeling user interface.

FIG. 16 illustrates a sampling configuration user interface.

FIG. 17 illustrates a technique configuration user interface.

FIG. 18 illustrates a sampling statistics user interface.

FIG. 19 illustrates a flowchart of a method for configuring sampling techniques.

FIG. 20 illustrates a flowchart of a method for training an authentication model.

FIG. 21 illustrates a block diagram of an embodiment of a computing device on which aspects of the present disclosure may be implemented.

### DETAILED DESCRIPTION

In accordance with aspects of the present disclosure, methods and systems for sampling, review, and model retraining relating to fraud attempts are provided. The methods and systems described herein may be applied in the context of high-volume transaction data where high accuracy is required, such as in the context of user authentication.

Identity verification systems face a fundamental challenge. Fraudulent authentication attempts are extremely rare events within massive volumes of legitimate transactions. In typical IDV deployments processing biometric authentication data (e.g., including facial images, videos, liveness detection results, and document verification outcomes) fraud may constitute a low percentage of total cases (e.g., 0.2%), while unidentified or novel fraud patterns may constitute a an even smaller percentage (e.g., in only 0.01-0.02% of authentication attempts).

This imbalance creates a critical detection problem. When IDV systems analyze millions of biometric data points daily (e.g., facial recognition submissions, liveness check results, document-to-selfie comparisons), the few fraudulent cases, including presentation attacks using photographs, video replays, masks, or AI-generated deepfakes, are buried within an overwhelming majority of legitimate authentication events. Traditional random sampling approaches, when applied uniformly across this production data, are statistically unlikely to capture sufficient fraud examples to train robust authentication models. The rarity of fraud means that most samples selected for manual review will be legitimate cases, resulting in inefficient use of limited human reviewer resources and slow identification of emerging attack vectors

In the IDV context, this sparsity problem is compounded by the evolving nature of biometric fraud. Malicious actors continuously develop sophisticated spoofing technique from high-resolution printed photos and 3D masks to GAN-generated deepfakes and injection attacks. Each new attack method initially appears as an exceptionally rare event in IDV data streams, making early detection through conventional sampling nearly impossible. Authentication models trained primarily on historical fraud patterns struggle to identify these novel biometric presentation attacks until they become prevalent enough to appear in standard samples by which point significant fraud losses have already occurred.

Embodiments of the present disclosure address IDV fraud rarity through a multi-pronged sampling strategy that increases the likelihood of identifying fraudulent biometric authentication cases within sparse production data. Rather than relying solely on random sampling, some embodiments employ multiple disparate and configurable sampling techniques specifically designed to surface different categories of potential fraud from IDV data streams.

Random sampling establishes a baseline by selecting biometric authentication cases uniformly across the production dataset, ensuring broad coverage of the authentication distribution and capturing any fraud that occurs with sufficient frequency. Rejection sampling specifically targets authentication attempts that failed liveness checks or were flagged by the authentication model as suspicious (e.g., cases where the system detected potential presentation attacks involving photos, videos, masks, or anomalous biometric patterns). This technique efficiently concentrates manual review resources on IDV transactions that the model already considers questionable, where the probability of identifying true fraud (or refining false positive detection) is substantially higher.

Uncertainty sampling addresses the challenge of near-miss fraud cases that barely passed authentication thresholds. This technique selects biometric authentication attempts where the model's confidence is low, for example, liveness scores near decision boundaries, cases where multiple authentication models disagree, or instances where different model components (facial matching vs. liveness detection vs. document verification) produce divergent results. These uncertain cases often represent novel fraud techniques that exploit edge cases in the authentication logic, or legitimate users with unusual biometric presentations that generate false rejections. By prioritizing these ambiguous IDV data points for human review, the system efficiently discovers both emerging fraud patterns and opportunities to reduce false rejection rates.

Diversity sampling provides examination for rare or underrepresented biometric patterns within the IDV data. Using embedding-based clustering of facial images and authentication context, this technique identifies outlier authentication attempts that differ significantly from the mainstream distribution—for example, unusual lighting conditions, uncommon facial accessories, demographic groups underrepresented in training data, or novel presentation attack types. By intentionally sampling from these sparse regions of the IDV feature space, the system increases the probability of discovering new fraud variants that would be missed by techniques focused on high-density regions or known failure patterns.

By combining these sampling techniques as disclosed herein, embodiments transform the needle-in-a-haystack problem of IDV fraud detection into a systematic discovery process. A combination of sampling techniques allow manual labeling efforts to efficiently target the most informative biometric data points rather than being diluted across predominantly legitimate cases.

Another challenge that is particularly acute in liveness detection systems is the ability to identify novel attach vectors. Liveness detection systems must distinguish live human presence from an expanding arsenal of spoofing techniques. Modern passive liveness systems analyze physiological cues (involuntary micro-movements, skin texture, light reflectivity), depth signals (3D facial structure), and behavioral consistency. However, when attackers develop new injection methods (e.g., inserting synthetic video streams directly into application data flows) or leverage advanced generative models that accurately reproduce these subtle cues, the liveness model initially lacks labeled training examples to recognize these attacks. The model confidently assigns high liveness scores to sophisticated deepfakes because they statistically resemble the legitimate biometric patterns in its training set.

This detection lag has severe consequences for IDV systems. During the period between a new attack method's emergence and the authentication model's update to detect it, fraudsters can systematically exploit the vulnerability across thousands of authentication attempts. Financial losses accumulate, fraudulent accounts proliferate, and by the time the pattern is recognized, substantial damage has occurred. Traditional model retraining cycles which depend on fraud being reported through external channels, incident investigations, or customer complaints—are too slow to address this rapid evolution.

Embodiments of the present disclosure create a continuous fraud discovery pipeline that systematically identifies novel IDV attack patterns before they achieve scale. The human-in-the-loop system treats each authentication attempt as a potential source of learning, using adaptive sampling to surface suspicious biometric presentations for expert review within the normal operational cycle.

When manual reviewers identify a case as fraudulent embodiments automatically identify other authentication attempts with similar characteristics in the embedding space and prioritize them for review. This ripple effect allows for rapid discovery as identifying one instance of a new deepfake technique triggers examination of similar cases, quickly building a labeled dataset of the novel fraud pattern. These newly labeled examples immediately feed into candidate model training, enabling the authentication system to deploy updated models that can recognize the new attack type within days rather than months.

The continuous training and deployment pipeline ensures accuracy improvements reach production rapidly. Newly labeled cases (fraud discoveries and edge case refinements) feed into candidate model training, which are evaluated against comprehensive test sets measuring both fraud detection rates and false rejection rates across demographic groups. When candidate models demonstrate statistically significant improvement (e.g., detected via A/B testing or holdout evaluation) the candidate models can be deployed to replace production models.

The result is authentication models that continuously improve in the dimensions most critical to IDV accuracy: detecting novel fraud (reducing false acceptance), refining decision boundaries (improving confidence), and accommodating edge cases (reducing false rejection), all while operating within practical manual review constraints. The system transforms accuracy improvement from an episodic retraining process into a continuous adaptation mechanism aligned with the dynamic nature of biometric fraud.

In examples, an authentication model may be deployed to authenticate users. A plurality of sampling techniques may be used to identify cases of potential fraud to be manually reviewed from among the authentication cases analyzed by the authentication model. The cases that are manually reviewed may be labeled based on the manual review and used to train a candidate authentication model. The candidate authentication model may be evaluated and, based on the performance of the candidate authentication model, deployed. This cycle may repeat, with samples taken from cases analyzed by the most recently deployed authentication model manually reviewed to identify cases of fraud that can be used to train the next authentication model.

By continuously looping through the process to train new authentication models and/or updating training of existing models for deployment, the authentication model that is deployed may adapt to identify new types of fraud attempted by malicious actors as the malicious actors develop new techniques to spoof authentication. Additionally, using a plurality of sampling techniques to identify potential cases of fraud allows for improved detection of various types of fraud, and particularly cases of missed fraud, to be selected for manual review and subsequently used to train the next iteration of the authentication model.

In some embodiments, the plurality of sampling techniques used may be configurable. For example, a user, such as an administrator, may select which sampling techniques are used to select the samples from the cases analyzed by the authentication model. Additionally, the user may set the number of samples selected using each sampling technique. Statistics associated with the sampling techniques may be provided to the user to aid the user in configuring the sampling techniques. In some embodiments, users may define constraints, and the configuration of sampling techniques may be set automatically based on the sampling statistics and the defined constraints. By allowing configuration of the sampling techniques, the sampling may more efficiently identify cases of potential fraud to be manually reviewed.

In some embodiments, additional samples may be selected based on cases identified as fraud during the manual review process. For example, when a case is identified as fraud during the manual review process, other cases that are similar to the identified fraud case may be selected for manual review. In an example, as described further herein, embeddings may be computed for each case analyzed by the authentication model, and the embeddings may be used to determine similar cases to the identified fraud case. Selecting samples based on cases identified as fraud during the manual review process may allow more cases of fraud to be identified while utilizing a similar manual review effort/budget. This results in faster identification and creation of training data used to improve and/or create authentication models.

In example uses, the sampling techniques described herein may be specifically applied in the context of authentication models used to detect liveness of a user. In this context, biometric information (e.g., image or video data) may be provided by a user, and the authentication model may generate a classification output indicating a confidence level of liveness of the individual presented in the biometric information. The sampling techniques described herein may be used in conjunction with human-in-loop annotation of samples to identify potential liveness fraud attempts and to retrain authentication models to better identify such fraud attempts.

In some instances, a plurality of sampling techniques may be applied to the same dataset, and different sampling techniques may be used adaptively across the available data to be analyzed. The sampling techniques may be selected based on the observed performance of an authentication model, e.g., to maintain broad sampling across authentication data while focusing sampling in areas of possible fraud. The approaches described herein allow for efficient identification of relevant samples that may be manually reviewed for potential fraud. That is, the sample set that is automatically generated by the systems described herein remains sized for efficient manual review, while providing improvements over existing techniques (e.g., random sampling across an overall sample population) in terms of identifying and isolating areas of potential fraud for review.

Biometric input data generally comprises the raw identity evidence submitted by users during authentication or enrollment. This includes facial images—typically selfie photographs captured via smartphone cameras or webcams—submitted when users attempt to access protected resources or create new accounts. These images serve as the primary biometric identifier, enabling facial recognition algorithms to compare the presented face against pre-registered reference templates stored during initial identity proofing. Additionally, systems increasingly capture facial videos, short recordings of the user's face from multiple angles or while performing specific movements, which may provide richer biometric data and enable dynamic liveness assessment. These videos originate from user-facing applications during authentication sessions and are transmitted to backend verification services for analysis.

Liveness detection outputs represent algorithmic assessments of whether the biometric presentation originates from a live human rather than a presentation attack. These data points are generated by liveness detection models that analyze the submitted images or videos. Passive liveness scores emerge from algorithms examining intrinsic image properties (e.g., skin texture patterns, light reflectivity characteristics, depth cues from facial structure, and involuntary micro-movements detected across video frames) without requiring user action. Active liveness indicators are produced when systems prompt users to perform specific actions (e.g., blinking, smiling, turning head) and evaluate whether the execution exhibits natural human characteristics or mechanical replay patterns. These liveness outputs serve the critical purpose of defending against presentation attacks including photographs held to cameras, video replays, 3D masks, or AI-generated deepfakes attempting to impersonate legitimate users.

Authentication model outputs comprise the decisions and confidence assessments generated by identity matching algorithms. Authentication scores, which may be probability values between 0 and 1, quantify the degree of match between the submitted biometric and the reference template, with higher scores indicating stronger identity correspondence. Pass/fail decisions represent binary authentication outcomes determined by comparing these scores against configured thresholds: scores exceeding the threshold grant access, while lower scores trigger rejection. Risk scores aggregate multiple signals (e.g., biometric match quality, liveness confidence, device reputation, behavioral consistency) into unified fraud probability assessments. These outputs determine whether users gain access to protected resources—financial accounts, government services, healthcare records, or corporate systems—making them the ultimate gatekeepers of security and user experience.

Supporting contextual data enriches authentication decisions with additional verification evidence. Pre-registered biometric templates, such as facial embeddings or feature vectors enrolled during initial identity proofing serve, as the ground truth against which authentication attempts are compared. Document verification results indicate whether government-issued identity documents (passports, driver's licenses) submitted alongside biometric selfies passed authenticity checks, OCR extraction, and document-to-selfie matching. Authentication metadata (e.g., timestamps, geolocation, device fingerprints, IP addresses, session characteristics) provide contextual signals that help distinguish legitimate user patterns from suspicious access attempts.

Embodiments of the present disclosure may operate on authentication cases which may comprise one or more of the aforementioned data elements. Each authentication case may represent a complete authentication attempt or, for example, one or more of: the biometric images or videos submitted by the user, the liveness scores generated by detection algorithms, the authentication decisions produced by matching models, and the contextual metadata associated with the session. The sampling techniques select which of these multi-dimensional authentication cases warrant manual review, and human experts may examine the complete data profile (e.g., visual inspection of biometric presentations, analysis of score patterns, consideration of contextual anomalies) to make fraud determinations.

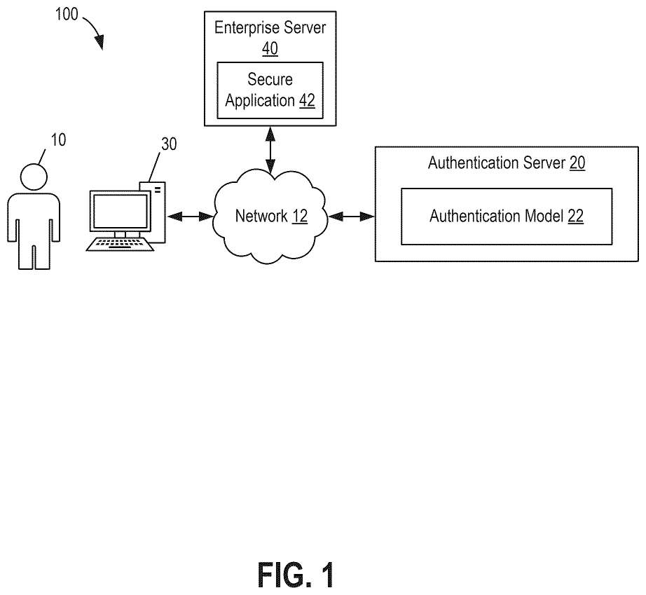

Referring to FIG. 1, an example environment 100 for authenticating users is provided. In the illustrated embodiment, the system 100 includes an authentication server 20, a computing device 30, and an enterprise server 40. In an example, a user 10 may attempt to access a secure application 42 on the enterprise server 40 through the computing device 30.

Computing device 30 comprises an electronic device in communication with system 100. For example, the computing device 30 may be connected to the enterprise server 40 over a network 12, such as the Internet. In an example, computing device 30 can be desktop computer, a laptop computer, tablet, mobile computing device, server, workstation, or Internet-of-things (IoT) device, among other electronic devices. Though depicted as a single computing device, system 100 can, in other embodiments, include a plurality of computing devices 30, such as a networked system of devices, accessible by one or more users.

In an embodiment, as illustrated in FIG. 1, authentication server 20 and enterprise server 40 are each implemented on a single device, having their own processor and memory. In embodiments, system 100 can be a cloud-based service such that customization and execution of authentication processes can be distributed across a network of multiple computing devices (e.g., with each device having its own processor and memory).

In an embodiment, access to the secure application 42 is controlled based on user authentication. The user 10 may submit an authentication request to the authentication server 20, and the authentication server 20 may verify the identity of the user 10 using an authentication model 22. In an example, the authentication model 22 may include a facial recognition model which may authenticate the user 10 based on an image or a video of the user's face. Authentication of a user may include identification of the user as corresponding to a particular authorized user identity, may include verification of the liveness of the user at the time of authentication, or a combination thereof. While one authentication model 22 is shown, in alternative embodiments, the authentication server 20 may include multiple authentication models 22 (e.g., with one or more models performing either of identification and/or liveness assessments). After the user 10 is authenticated, the user 10 may be granted access to the secure application 42.

In some examples, the user 10 may be a malicious actor who is not authorized to access the secure application 42. The user 10 may attempt to bypass authentication to access the secure application 42 using a number of fraudulent techniques. For example, the user 10 may submit an image or video of a different user in an attempt to fool the authentication model 22. In some cases, the authentication model 22 may identify that the user 10 is not who they claim to be and deny the user 10 access to the secure resource 42. However, in other cases, the authentication model 22 may be misled by the user 10 and incorrectly grant the user 10 access to the secure resource 42. For example, the authentication model 22 may incorrectly determine that an image or video that is received is of a live person matching the biometric profile of a known or trusted user, despite the image depicting a photograph, mask, or other reproduction of the person (i.e., a person who is not live and present in the image).

Described herein is a process for improving the authentication model 22 by identifying cases of fraud that can be used to train the authentication model 22, or other authentication models that can be deployed in place of the authentication model 22. By continuously identifying new cases of fraud, the authentication model 22 can be trained to identify new fraudulent techniques used by malicious actors to try to mislead or fool the authentication model 22.

In some instances, because the authentication model 22 may be used for a high volume of authentication determinations, the authentication determinations may be sampled for inspection and validation. As described in further detail below, because of the evolving nature of attempted fraudulent authentication techniques, some but not all such attempted fraudulent authentications may be detected. The sampling may utilize a number of different sampling techniques or methodologies to ensure fraudulent authentication attempts are well represented within the sampled data. This can include, for example, sampling across an entire distribution, sampling in a region or cluster of emerging unsuccessful authentication attempts, and the like. In this context, each sample may be based on a determination by the authentication model, and may involve presented biometric data (e.g., the image or video presented at the time of attempted authentication), optionally pre-registered biometric data (in the case of identity verification models) and a determination result from the authentication model 22 (e.g., a pass or fail status, confidence level, or the like, of the attempted authentication).

While examples herein may describe using a facial authentication model to authenticate users based on images or videos submitted by the users, in other examples, other types of authentication models may be used. Accordingly, other types of data, such as other types of biometric data (e.g., retina scan data, palm print or fingerprint data, and the like), may be submitted by the users during the authentication process.

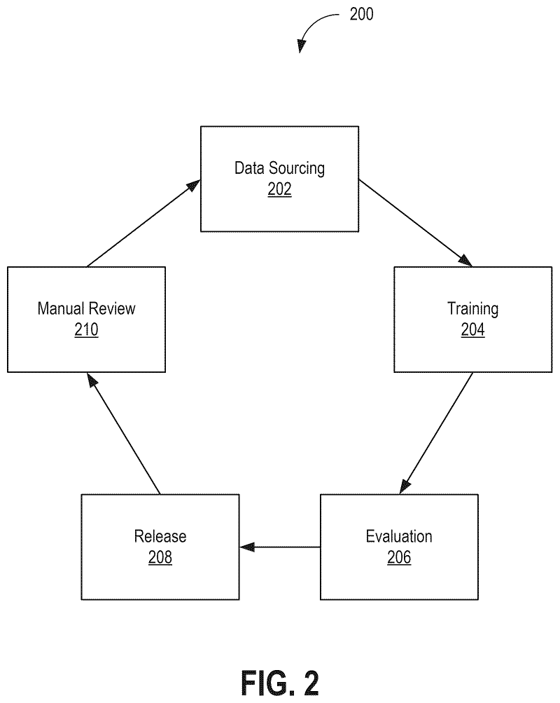

FIG. 2 illustrates a flowchart of an example method 200 for identifying cases of fraud and using the identified cases to train authentication models. In the illustrated example, the method 200 includes operations 202, 204, 206, 208, 210. In examples, the method 200 may be performed by an authentication server, such as the authentication server 20 described above in connection with FIG. 1.

The operation 202 includes sourcing data. In embodiments, production data is collected. In an example, the production data may include data used by and output by an authentication model. For example, if the authentication model includes a facial recognition model, the data forming a given “sample” of an authentication attempt may include images and videos submitted by users as well as the authentication result output by the authentication model.

In example embodiments, the sourced data includes data from cases identified as fraud by administrators of the authentication server. For example, an administrator may actively parse through the production data to identify cases of fraud. Similarly, as described further herein, potential fraud cases may be identified by sampling the production data according to a particular sampling technique, and these potential fraud cases may be provided to an administrator for manual review. The results of the manual review process may be included in the sourced data.

In some example embodiments, the sourced data includes data from cases identified as fraud by users of the authentication server. For example, an enterprise that uses the authentication server for authentication services to protect a secure resource may report cases of fraud that were not identified by the authentication model.

Labels may be applied to the sourced data. For example, each case may be associated with a label that identifies the case as either legitimate or fraud. In an embodiment, the labels may be based on the output of the authentication model. In cases of fraud identified by an administrator or other user, the label may be based on the review by the administrator. The labeled data may be stored in a database and used to train authentication models.

The operation 204 includes training a candidate authentication model. In embodiments, preprocessed samples are generated using the labeled data stored during the operation 202. One or more candidate authentication models may be trained using the preprocessed samples (e.g., preprocessed images). In an example, the preprocessed samples include images or videos of users faces, or embeddings thereof, and are used to train a facial recognition model. In some instances, the preprocessed samples may be tensor flow (TF) records.

The operation 206 includes evaluating the candidate authentication model. In an example, testing data is generated from the labeled data stored during the operation 202. The candidate authentication model may be evaluated using the testing data. For example, one or more evaluation metrics may be calculated for the candidate authentication model, such as a percentage of fraudulent cases identified as legitimate and a percentage of legitimate cases identified as fraudulent.

Based on the evaluation during the operation 206, the candidate authentication model may be deployed. For example, if the candidate authentication model performs better than the deployed authentication model, the candidate authentication model may be deployed in place of the deployed authentication model.

The operation 208 includes deploying the candidate authentication model. In some examples, the method 200 may skip the operation 208 if the candidate authentication model should not be deployed. For example, if the candidate authentication model performs worse than the deployed authentication model, the candidate authentication model may not be deployed, and the method 200 may skip the operation 208.

The operation 210 includes performing a manual review process. In embodiments, samples are collected from production data—e.g., cases that are analyzed by the deployed authentication model. As described further herein, a plurality of sampling techniques may be used to select samples from the production data. The samples may be provided to one or more administrators'computing devices for the administrators to manually review the cases and determine if the cases are legitimate or fraudulent.

As described above, the results of the manual review process conducted during the operation 210 may be included in the data sourced during the operation 202. The method 200 may repeatedly loop through the operations 202-210, continuously training new authentication models that may be deployed to more accurately identify fraud as malicious actors change their techniques.

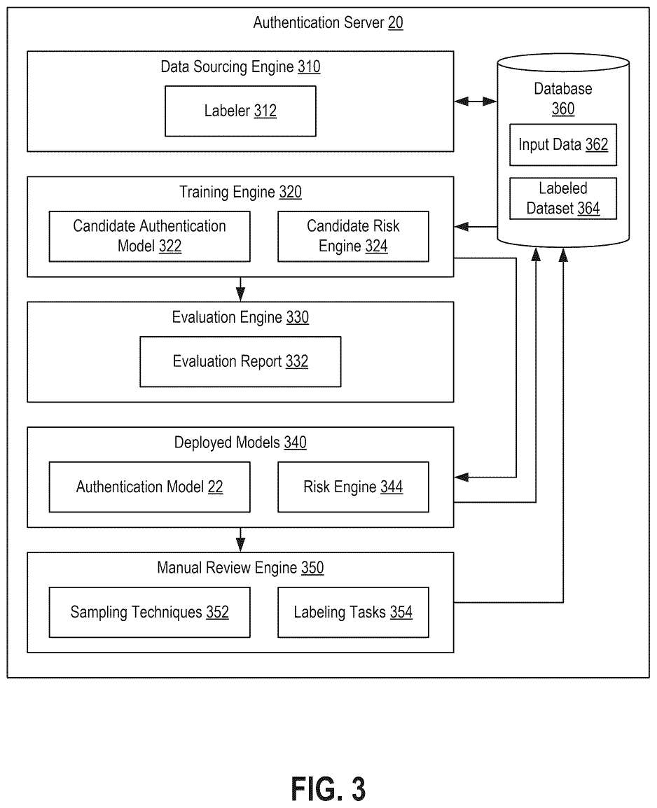

FIG. 3 illustrates an embodiment of an authentication server 20. In an embodiment, the authentication server 20 includes a data sourcing engine 310, a training engine 320, an evaluation engine 330, deployed models 340, a manual review engine 350, and a database 360. In examples, the authentication server 20 may repeatedly train and deploy authentication models to adapt to new fraud techniques employed by malicious actors. The authentication server 20 may be implemented using one or more server systems, and may be implemented using separate computing systems to implement the various engines and database systems described herein.

The data sourcing engine 310 may collect data that can be used to train authentication models. In an embodiment, the data sourcing engine 310 generates labeled data based on input data 362. For example, as described above, the input data 362 may include production data—e.g., data associated with cases analyzed by an authentication model 22. The input data 362 may include cases that were reviewed by administrators of the authentication server 20, such as cases reviewed during a manual review process. In an example, the input data 362 is stored in the database 360.

The data sourcing engine 310 may use a labeler 312 to label the input data 362. For example, the data may be labeled with authentication results output by the authentication model 22. The labeled data 364 may then be stored in the database 360.

The training engine 320 may use the labeled dataset 364 to train candidate models. In the illustrated example, the candidate models include a candidate authentication model 322 and a candidate risk engine 324. In an example, the candidate authentication model 322 may be trained to authenticate a user using an image or a video of the user's face. In an example, the candidate risk engine 324 may be trained to calculate a risk score associated with authenticating the user.

In embodiments, the training engine 320 may generate preprocessed samples (e.g., TF records) using the labeled dataset 354. The preprocessed samples may then be used to train the candidate authentication model 322 and the candidate risk engine 324.

While the illustrated example shows one candidate authentication model 322 and one candidate risk engine 324, in alternative examples, the training engine 320 may train a plurality of candidate authentication models or a plurality of candidate risk engines. In some embodiments, the training engine 320 may train the candidate authentication model 322 without training the candidate risk engine 324. Similarly, in some embodiments, the training engine 320 may train the candidate risk engine 324 without training the candidate authentication model 322.

The evaluation engine 330 may evaluate the candidate authentication model 322 and the candidate risk engine 324. For example, the evaluation engine 330 may generate an evaluation report 332 that can be analyzed by an administrator of the authentication server 20 to determine a performance of the candidate authentication model 322 and the candidate risk engine 324. In embodiments, the evaluation report 332 may include one or more performance metrics associated with the candidate authentication model 322 and the candidate risk model 324. For example, the evaluation report 332 may include a percentage of fraudulent cases identified as legitimate by the candidate authentication model and a percentage of legitimate cases identified as fraudulent by the candidate authentication model. In some embodiments, the evaluation report 332 may include similar performance metrics for the deployed models 340—e.g., the authentication model 22 and a deployed risk engine 344. The evaluation report 332 may then be used to compare the performance of the candidate authentication model 322 to the deployed authentication model 22 and the candidate risk engine 324 to the deployed risk engine 344.

Based on the evaluation of the candidate authentication model 322 and the candidate risk engine 324, the candidate authentication model 322 and the candidate risk engine 324 may be deployed in place of the deployed models 340—i.e., the authentication model 22 and the risk engine 344, respectively. For example, if the candidate authentication model 322 performs better than the authentication model 22—e.g., the candidate authentication model 322 more accurately identifies fraudulent cases—the candidate authentication model 322 may be deployed in place of the authentication model 22.

Samples from production data, such as data associated with cases analyzed by the deployed models 340, may be selected for review by the manual review engine 350. Manually reviewing the samples may allow for more cases of fraud to be found and used to train the candidate models that can then better identify similar cases of fraud.

One or more sampling techniques 352 may be used to select the samples to be reviewed. As described further herein, the sampling techniques 352 may be configurable, allowing for an administrator of the authentication server 20 to select samplings techniques to be included in the sampling techniques 352 as well as changing properties of the sampling techniques 352, such as a number of samples selected by each of the sampling techniques 352. By using multiple sampling techniques 352 different types of cases can be selected for review, which may lead to more fraudulent cases being identified.

After samples are selected using the sampling techniques 352, labeling tasks 354 are created. The labeling tasks 354 may include cases to be manually reviewed to be determined if the case is legitimate or fraudulent. The labeling tasks 354 may then be transmitted to one or more computing devices so that a user, such as an administrator, may review the associated cases and determine if the cases are legitimate or fraudulent. The results of the labeling tasks 354 may be returned to the authentication server 20 and saved with the input data 362 that is used to train the next iteration of candidate models.

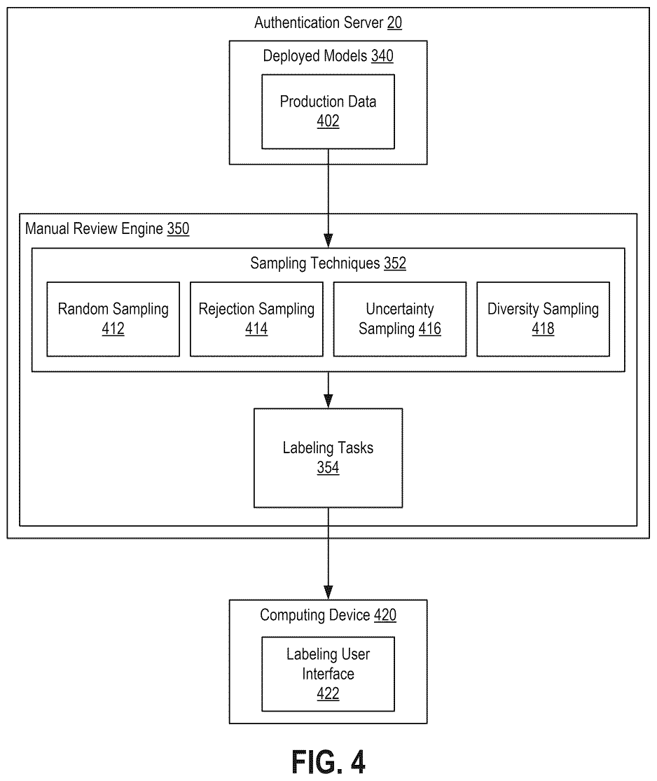

FIG. 4 illustrates a detailed view of the authentication server 20 for conducting a manual review process. In the illustrated example, the authentication server 20 includes one or more deployed models 340 and a manual review engine 350. The authentication server 20 may be connected to a computing device 420. In an example, the authentication server 20 and the computing device 420 are connected over a network, such as the Internet.

As described above, the authentication server may include one or more deployed models 340 that perform authentication of users, such as facial authentication. As the deployed models 340 authenticate users, the deployed models 340 create production data 402. In examples, the production data 402 includes images or videos submitted by the users for authentication and results of the authentication.

The manual review engine 350 uses samples from the production data 402 to create labeling tasks 354 to be manually reviewed. The manual review engine 350 may use one or more sampling techniques 352 to select the samples for the labeling tasks 354. In the illustrated example, the manual review uses a plurality of sampling techniques 352: random sampling 412, rejection sampling 414, uncertainty sampling 416, and diversity sampling 418. In alternative embodiments, additional or alternative sampling techniques 352 may be used by the manual review engine 350 to select the samples for the labeling tasks 354. In some embodiments, a subset of the sampling techniques 352 may be used to select samples for the labeling tasks 354.

In some embodiments, as described further herein, the sampling techniques 352 may be configurable. In example, an administrator of the authentication server 20 may select which sampling techniques 352 to use. For example, the administrator may select for the manual review engine 350 to use random sampling 412 and rejection sampling 414 but not uncertainty sampling 416 or diversity sampling 418. Similarly, the administrator of the authentication server 20 may set how many samples each of the sampling techniques 352 select. For example, the administrator may select for each sampling technique 352 to select one hundred samples. In other examples, the administrator may set an upper limit of samples selected by each sampling technique 352 and a lower limit of samples selected by each sampling technique 352, and the number of samples selected by each sampling technique 352 may be set automatically to be within these defined restraints.

The labeling tasks 354 may be transmitted to the computing device 420 for an administrator to manually review the labeling tasks 354. While the illustrated example shows a single computing device 420 receiving the labeling tasks 354, in another example, the labeling tasks 354 may be distributed to a plurality of computing device 420, with each of the plurality of computing devices 420 receiving a subset of the labeling tasks 354. Alternatively, each of the plurality of computing devices 420 may receive the entire set of labeling tasks 354.

The computing device 420 may present the labeling tasks 354 to the administrator through a labeling user interface 422. For example, the labeling user interface 422 may present the image or video submitted by the user being authenticated, and the administrator may analyze the image and determine if the authentication attempt is legitimate or fraudulent. An example labeling user interface 422 is described further herein.

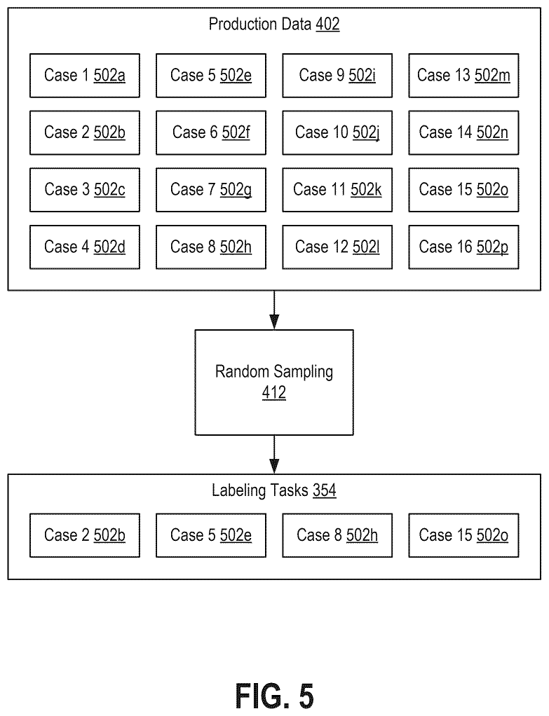

FIGS. 5-14 illustrated examples of different sampling techniques that may be used to select samples for manual review. While example sampling techniques are shown and described herein, the scope of the present disclosure is not limited to these example sampling techniques; in alternative embodiments, additional or alternative sampling techniques may be used to select sample authentication attempts for manual review.

FIG. 5 illustrates an example of random sampling. As shown in the illustrated example, random sampling 412 may be used to select samples from production data 402. The production data 402 may include a plurality of cases 502 that were analyzed by an authentication model. In an example, each case 502 in the production data 402 may include an image or video submitted by a user being authenticated.

The random sampling 412 may randomly select cases 502 from the production data for labeling tasks 354. For example, in the illustrated example, a second case 502b, a fifth case 502e, an eighth case 502h, and a fifteenth case 502o may be selected through random sampling 412. In alternative examples, a different number of cases 502 may be selected using random sampling 412. As described herein, an administrator may set the number of samples to be selected using random sampling 412.

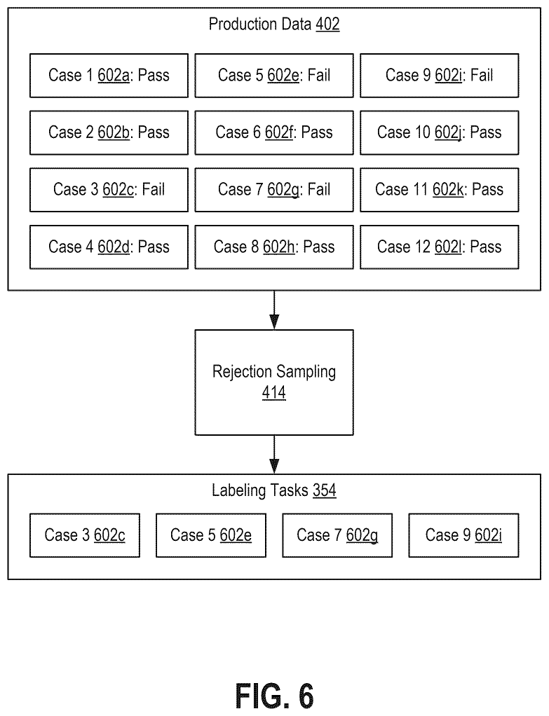

FIG. 6 illustrates an example of rejection sampling. As with other sampling techniques described herein, rejection sampling 414 may be used to select samples from production data 402. The production data 402 may include a plurality of cases 602 that were analyzed by an authentication model. In an example, each case 602 in the production data 402 may include an image or video submitted by a user being authenticated. Each case 602 may also be associated with an authentication result—e.g., pass or fail.

Rejection sampling 414 may select cases 602 that were rejected—i.e., cases 602 for which the authentication result is “fail.” Accordingly, in the illustrated example, a third case 602c, a fifth case 602e, a seventh case 602g, and a ninth case 602i are selected by the rejection sampling 414 for the labeling tasks 354. In some embodiments, each of the cases 602 that were rejected by the authentication model are selected with rejection sampling 414. In other embodiments, a subset of the cases 602 that were rejected by the authentication model are selected with rejection sampling 414. For example, random sampling may be used to select a subject of the rejected cases 602. As described herein, an administrator may set the number of samples to be selected using rejection sampling 414.

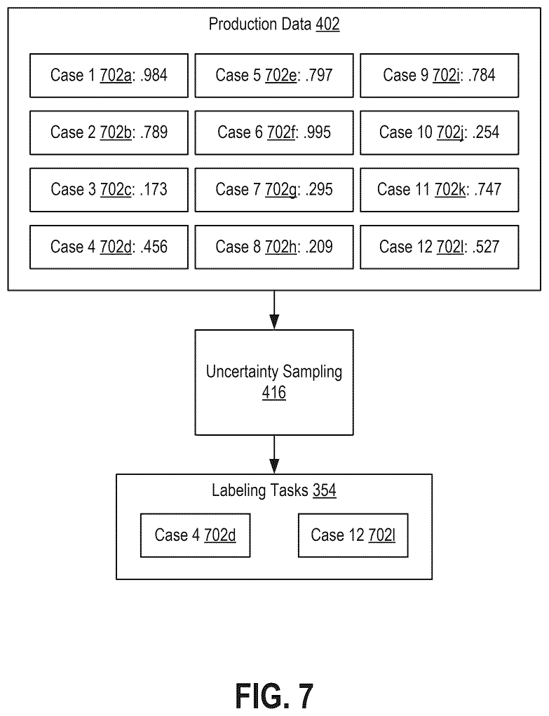

FIGS. 7-9 illustrate examples of uncertainty sampling. In the example illustrated in FIG. 7, uncertainty sampling 416 may include near-decision boundary sampling. As with other sampling techniques described herein, the uncertainty sampling 416 may be used to select samples from production data 402. The production data 402 may include a plurality of cases 702 that were analyzed by an authentication model. In an example, each case 702 in the production data 402 may include an image or video submitted by a user being authenticated. Each case 702 may also be associated with an authentication score. For example, a decision boundary may be set at 0.500; users may be authenticated in cases 702 in which the authentication score is above the decision boundary, and users may be rejected in cases 702 in which the authentication score is below the decision boundary.

In embodiments in which the uncertainty sampling 416 includes near-decision boundary sampling, cases 702 may be selected for labeling tasks 354 for which the authentication score is within a predetermined distance from the decision boundary. For example, in the illustrated embodiment, the decision boundary may be set at 0.500 and the predetermined distance may be 0.050. In this example, cases 702 for which the authentication score is between 0.450 and 0.550. Accordingly, in the illustrated example, a fourth case 702d and a twelfth case 702l may be selected using uncertainty sampling 416.

In some embodiments, each of the cases 702 for which the authentication score is less than the predetermined distance from the decision boundary may be selected for labeling tasks 354. In other embodiments, a subset of the cases 702 for which the authentication score is less than the predetermined distance from the decision boundary may be selected for labeling tasks 354. For example, a predetermined number of the closest cases 702 to the decision boundary may be selected. As described herein, an administrator may set the number of samples to be selected using uncertainty sampling 416.

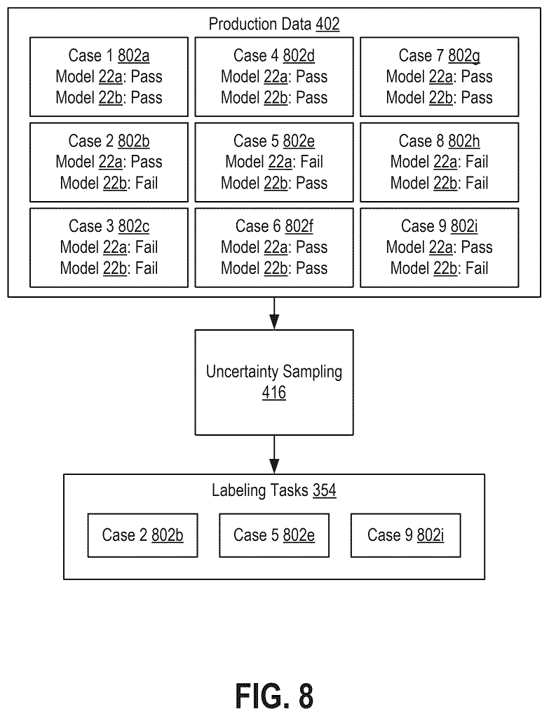

FIG. 8 illustrates another example of uncertainty sampling. In the example shown in FIG. 8, the uncertainty sampling 416 may include different decision disagreement sampling. As with other sampling techniques described herein, uncertainty sampling 416 may be used to select samples from production data 802. The production data 402 may include a plurality of cases 802 that were analyzed by an authentication model. In an example, each case 802 in the production data 402 may include an image or video submitted by a user being authenticated. Each case 802 may also be associated with a plurality of authentication results—e.g., pass or fail. Each of the authentication results associated with a case 802 may be output by a different authentication model 22.

Different decision disagreement sampling may select cases 802 for which the authentication results are different among the authentication models 22. For example, a second case 802b may be selected for a labeling task 354 because a first authentication model 22a authenticated the user and a second model 22b rejected the user. Similarly, a fifth case 802e and a ninth case 802i may be selected for labeling tasks 354.

While the illustrated example illustrates two authentication models 22 providing authentication results, in alternative embodiments, three or more authentication models 22 may be used by an authentication server. In such embodiments, the uncertainty sampling 416 may select cases 802 in which the authentication results are not unanimous across the authentication models 22. In other embodiments, the uncertainty sampling 416 may select cases in which a predetermined number of the authentication models 22 disagree with each other.

In some embodiments, each of the cases 802 for which the authentication results are different between the authentication models 22 may be selected for labeling tasks 354. In other embodiments, a subset of the cases 802 for which the authentication results are different between the authentication models 22 may be selected for labeling tasks 354. As described herein, an administrator may set the number of samples to be selected using uncertainty sampling 416.

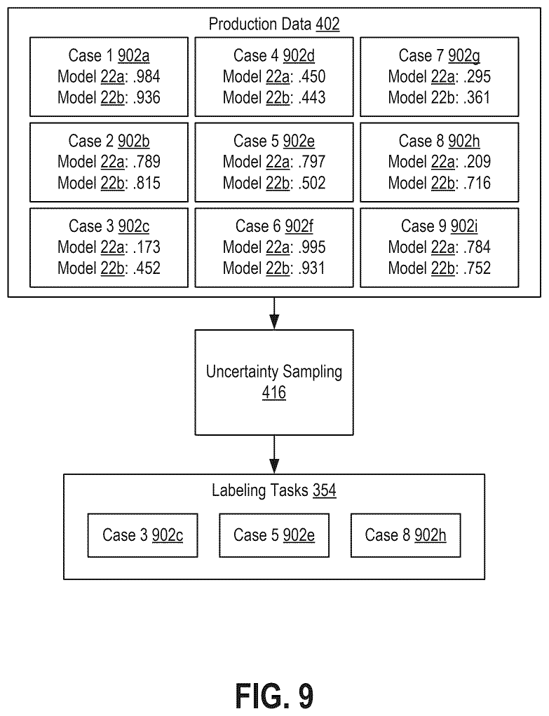

FIG. 9 illustrates a third example of uncertainty sampling. In the example shown in FIG. 8, the uncertainty sampling 416 may include furthest score disagreement sampling. As with other sampling techniques described herein, uncertainty sampling 416 may be used to select samples from production data 402. The production data 402 may include a plurality of cases 902 that were analyzed by an authentication model. In an example, each case 902 in the production data 402 may include an image or video submitted by a user being authenticated. Each case 902 may also be associated with a plurality of authentication scores from a plurality of authentication models 22.

Furthest score disagreement sampling may select cases for which a difference between the authentication scores is greater than a predetermined difference. For example, in the illustrated example, the predetermined difference may be 0.250. Accordingly, a third case 902c, a fifth case 902e, and an eighth case 902h may be selected by the uncertainty sampling 416 for labeling tasks 354.

While the illustrated example shows two authentication models 22 providing authentication scores, in alternative examples, three or more authentication models 22 may provide authentication scores. In such examples, the uncertainty sampling 416 may select cases 902 for which any of the differences between authentication scores are greater than the predetermined difference. In another example, the uncertainty sampling 416 may select cases 902 for which the average difference between authentication scores is greater than the predetermined difference.

In some embodiments, each case 902 for which the difference between authentication scores is greater than the predetermined difference is selected by the uncertainty sampling 416. In other embodiments, a subset of cases 902 for which the difference between authentication scores is greater than the predetermined difference is selected, such as a predetermined number of cases 902 with the greatest differences in authentication scores. As described herein, an administrator may set the number of samples to be selected using uncertainty sampling 416.

Diversity sampling may be used to track and reduce model bias. Diversity sampling can include, for example, out of distribution approaches (e.g., cluster-based sampling) or targeted approaches (e.g., prompt-based sampling). These approaches are configured to identify uncommon data points from production data to, for example, lower false rejection rates.

Out-of-distribution approaches to diversity sampling generally include capturing rare or underrepresented data points. For example, cluster-based sampling groups the population into clusters based on shared characteristics. Once clusters are formed, samples are taken from each cluster to represent a wide variety of features. This allows smaller, less frequent clusters to be included, capturing out-of-distribution data. Targeted approaches to diversity sampling like prompt-based sampling aim to enhance diversity in a sample by focusing on specific characteristics or traits that are underrepresented. In prompt-based sampling, researchers or algorithms generate specific prompts or queries to actively seek out data points belonging to diverse or rare categories. This technique ensures that the sampling process intentionally includes characteristics or patterns that might otherwise be overlooked, addressing potential gaps in representation.

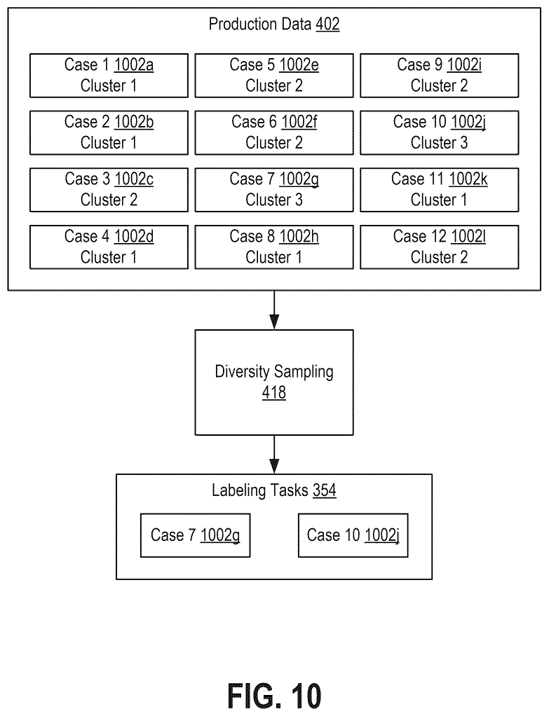

FIG. 10 illustrates an example of diversity sampling. As with other sampling techniques described herein, diversity sampling 418 may be used to select samples from production data 402. The production data 402 may include a plurality of cases 1002 that were analyzed by an authentication model. In an example, each case 1002 in the production data 402 may include an image or video submitted by a user being authenticated. The cases 1002 may be clustered based on the image/video, as described further herein.

The diversity sampling 418 may select cases 1002 for the labeling tasks 354 based on the clusters. For example, cases 1002 may be selected that are associated with small or sparse clusters. As described above, a significant majority of cases submitted to the authentication model may be legitimate, so the largest clusters may be associated with cases 1002 that are legitimate. By selecting small clusters, the diversity sampling 418 may be more likely to select cases 1002 that are fraudulent. Further, the smallest clusters may be associated with cases 1002 of fraud in which malicious actors are using new techniques to attempt to trick the authentication model. These cases 1002 are important to identify so that the authentication model can be trained to properly identify the new fraud techniques. In the illustrated example, the diversity sampling 418 may select a seventh case 1002g and a tenth case 1002j. In this example, the seventh case 1002g and the tenth case 1002j are assigned to a third cluster, which is the smallest cluster.

In some embodiments, cases 1002 are selected from clusters having a size less than a predetermined threshold. In an example, each case 1002 associated with a cluster having a size less than the predetermined threshold is selected by the diversity sampling 418. In other examples, a subset of the cases 1002 associated with a cluster having a size less than the predetermined threshold is selected by the diversity sampling 418. Additionally, while the illustrated example shows each of the sampled cases 1002g, 1002j belonging to the same cluster, in other examples, cases 1002 may be selected from a plurality of clusters. As described herein, an administrator may set the number of samples to be selected using diversity sampling 418.

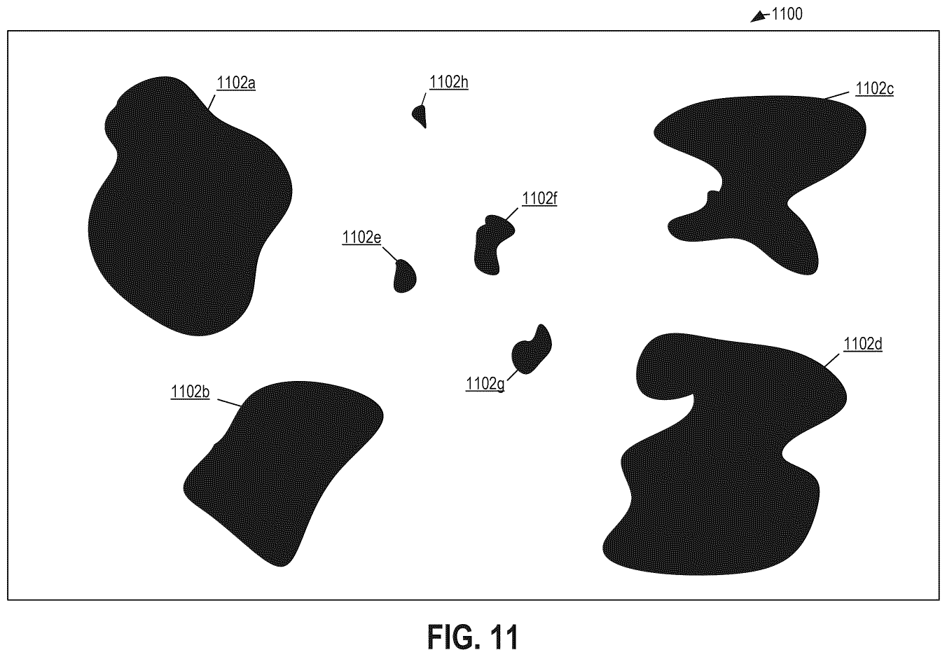

FIG. 11 illustrates an example visualization 1100 of clusters 1102 of authentication cases. In embodiments, embeddings of the images or videos submitted by users in the authentication cases may be generated. For example, frames from the videos may be selected, and a contrastive language-image pre-training (CLIP) model may generate an embedding of the frames. In some examples, using the CLIP model to generate embeddings may also allow authentication cases to be searchable by administrators using natural language. For example, administrators may search for authentication cases in which a user is wearing a mask, and the embeddings generated by the CLIP model may be used to identify such authentication cases.

The embeddings for each of the cases may be joined together in a matrix. In some instances, due to the high dimensionality of such a matrix based on the size of the embeddings output by the CLIP model, a Uniform Manifold Approximation and Projection (UMAP) may be used to reduce the dimensions of the matrix. In some instances, t-distributed Stochastic Neighbor Embedding (t-SNE) or Principal Component Analysis (PCA) are used for dimensionality reduction. Clustering may be performed on the dimension-reduced matrix using hierarchical density-based spatial clustering of applications with noise (HDBSCAN), and samples may be selected from the clusters, as described above. In some instances, K-means or Gaussian Mixture Model (GMM) are used for clustering. For example, K-means can be used for uncovering patterns in datasets where the categories are not labeled.

In the illustrated example, the visualization 1100 includes eight clusters 1102. In other examples, cases may be clustered into more or fewer clusters 1102. In this example, a first cluster 1102a, a second cluster 1102b, a third cluster 1102c, and a fourth cluster 1102d may be associated with legitimate cases. Because the legitimate cases make up a significant majority of cases, the clusters 1102a-d associated with legitimate cases may be the largest. Each of the clusters 1102a-d may correspond to different types of users or users for which the image or video was captured under different conditions (e.g., inside or outside).

In some cases, one or more smaller clusters, such as a fifth cluster 1102e, may also be associated with legitimate cases. In an example, the fifth cluster 1102e may be associated with uncommon types of users or uncommon conditions. For example, the fifth cluster 1102e may be associated with users who captured the image or video while wearing a helmet.

Other smaller clusters, such as a sixth cluster 1102f and a seventh cluster 1102g may be associated with fraudulent cases. For example, the sixth cluster 1102f may be associated with malicious actors who wear a mask to attempt to fool the authentication model, and the seventh cluster 1102g may be associated with malicious actors who hold an image of a different user to the camera when the image or video is captured to attempt to fool the authentication model. Because fraudulent cases are a small percentage of the total number of authentication cases, the clusters 1102f, 1102g associated with fraudulent attempts may be smaller than clusters 1102a-d associated with legitimate cases.

In some examples, fraud rings (e.g., a malicious actor or a group of malicious actors) may frequently attempt to fool the authentication model. Accordingly, there may be similarities across the images and videos submitted by the fraud rings that can cause the cases to be clustered together. For example, each of the images and videos submitted by the fraud ring may have the same background, which may cause the cases to be clustered together as the images and videos are similar.

Additionally, in examples, there may be clusters associated with unknown fraudulent attempts, i.e., cases that the authentication model does not recognize as fraud. For example, these cases may occur when malicious actors use new techniques to attempt to fool the authentication model that the authentication model has not been trained to identify. Accordingly, these cases may be associated with the smallest clusters as the malicious actors have not used the new techniques as frequently as other fraud techniques. In the illustrated example, an eighth cluster 1102h may be associated with unknown fraudulent cases.

By using diversity sampling to select cases for manual review based on the size of the clusters, more fraudulent cases—and more unknown fraudulent cases—may be selected for review and identified as fraud to train new iterations of the authentication models. This may allow the authentication models to accurately identify cases that were previously unknown fraudulent cases.

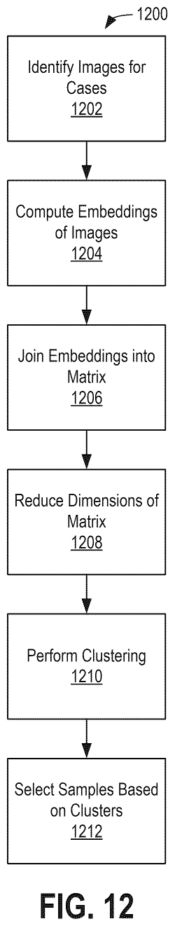

FIG. 12 illustrates a flowchart of an example method 1200 for selecting samples for manual review using diversity sampling. In the illustrated example, the method 1200 includes operations 1202, 1204, 1206, 1208, 1210, 1212. In an embodiment, an authentication server may perform the method 1200. For example, a manual review engine operating on the authentication server may perform the method 1200.

The operation 1202 includes identifying images for a plurality of cases. For example, the cases may be cases from production data, such as cases that were analyzed by an authentication model. Each of the cases may be associated with a video of a user submitted by the user for authentication of the user. In embodiments, a frame is extracted from each video associated with the plurality of cases. In other embodiments, the cases may be associated with images submitted by the user, and the submitted images may be used for the following operations.

The operation 1204 includes computing embeddings of the images identified during the operation 1202. In an example, a CLIP model is used to compute the embeddings of the images. The embeddings are then joined into a matrix during the operation 1206. Dimensionality reduction is performed on the matrix during the operation 1208. For example, UMAP may be used to reduce the dimensions of the matrix.

The operation 1210 includes performing clustering on the dimension-reduced matrix. In an example, HDBSCAN is used to perform the clustering. As described above, the clustering may create clusters that are associated with legitimate cases and fraudulent cases, as legitimate cases are likely to be similar to other legitimate cases and fraudulent cases are more likely to be similar to other fraudulent cases.

The operation 1212 includes selecting samples based on the clusters. In an example, the samples are selected based on sizes of the cluster. For example, samples may be selected from samples that have a size less than a predetermined threshold. Because fraudulent cases make up a small percentage of total cases, the small clusters are more likely to be associated with fraudulent cases. As described further herein, an administrator may configure how sampling is performed based on the clusters.

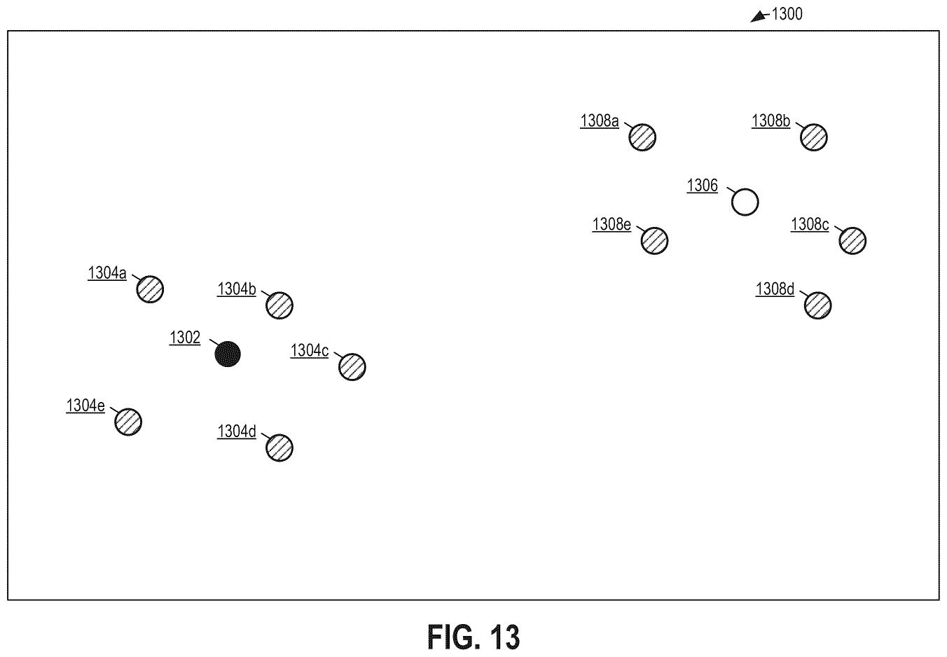

FIG. 13 illustrates an example of an iterative sampling technique for identifying more cases of fraud. FIG. 13 shows a visualization 1300 of authentication cases 1302, 1304, 1306, 1308. For example, embeddings may be generated for the cases 1302-1308, as described above, and the embeddings may be shown in the visualization. In this example, a first case 1302 and a second case 1306 may be cases that were sampled, such as by using a sampling technique described above, and reviewed during a manual review process. During the manual review process, the first case 1302 may be identified as a fraudulent case, and the second case 1306 may be identified as a legitimate case.

Based on the identification of the first case 1302 as a fraudulent case and the second case 1306 as a legitimate case, iterative sampling may be used to identify other potential fraudulent cases. For example, cases 1304 that are similar to the first case 1302, which was identified as a fraudulent case, may be selected for manual review. Because fraudulent cases may be similar to other fraudulent cases, as described above, the cases 1304 that are similar to the first case 1302 may also be fraudulent cases. In an example, a nearest neighbors algorithm is used to select the cases that are similar to the cases identified as fraudulent. In an alternative example, cases that are less than a predetermined distance away from the cases identified as fraudulent are selected. For example, Euclidean distance may be used to calculate the distance between the cases. Conversely, because legitimate cases may be similar to other legitimate cases, the cases 1308 that are similar to the second case 1306, which was identifies as a legitimate case, may not be selected for manual review during the iterative sampling.

The iterative sampling process may repeat multiple times. For example, a case 1304a that was selected for manual review because of the similarity with the first case 1302 that was identified as a fraudulent case may also be identified as a fraudulent case. Cases that are similar to the case 1304a may then be selected for manual review. In examples, the iterative sampling process may repeat for a predetermined number of iterations. In other examples, the iterative sampling process may repeat until no new fraudulent cases are identified.

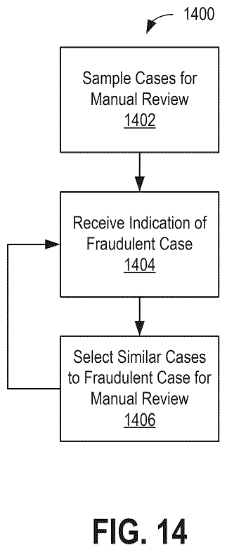

FIG. 14 illustrates a flowchart of an example method 1400 for performing an iterative sampling technique. In the illustrated embodiment, the method 1400 includes operations 1402, 1404, 1406. In an example, the method 1400 may be performed by an authentication server. For example, the method 1400 may be performed by a manual review engine operating on the authentication server.

The operation 1402 includes sampling cases for manual review. In an example, one or more of the sampling techniques described above may be used to sample cases for manual review. For example, random sampling, rejection sampling, uncertainty sampling, and diversity sampling may be used to select samples for manual review. Labeling tasks may be created for the sampled cases and transmitted to administrators for manual review.

The operation 1404 includes receiving an indication of a fraudulent case. For example, a case may be identified as a fraudulent case during the manual review process. The operation 1406 includes selecting cases that are similar to the fraudulent case for manual review. As described above, in an embodiment, the cases may be clustered based on the images and videos submitted with the cases. A nearest neighbor algorithm may be used to select cases that are similar to the fraudulent case. Labeling tasks may be created for the similar cases that are selected, and the labeling tasks may be transmitted to administrators for manual review.

The operations 1404, 1406 may loop to continue to identify further fraudulent cases. In some embodiments, the operations 1404, 1406 may loop a predetermined number of times. In other embodiments, the operations 1404, 1406 may loop until no more fraudulent cases are identified during the manual review process.

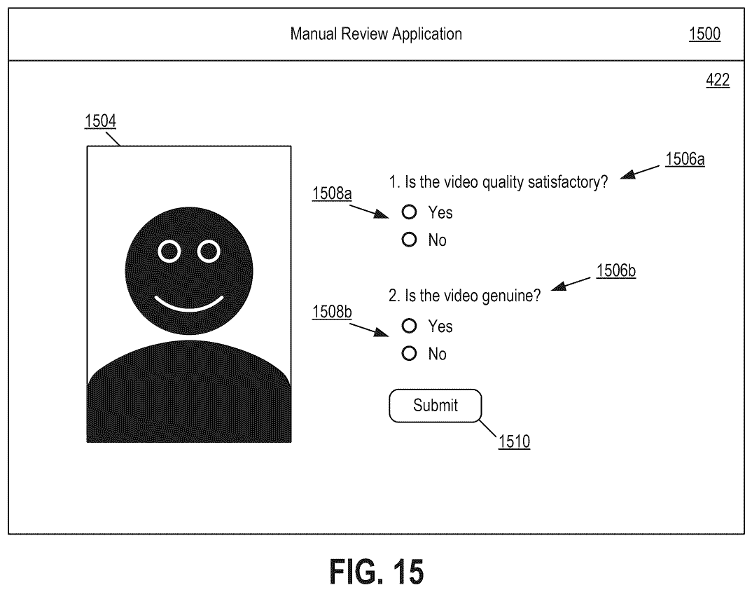

Turning to FIGS. 15-18, example user interfaces associated with a manual review process are shown. In embodiments, the user interfaces may be shown in a manual review application 1500, which may execute on a computing device, such as the computing device 420 described above in connection with FIG. 4. In other embodiments, the user interfaces may be shown in a browser operating on a computing device connected to an authentication server, such as over the Internet.

FIG. 15 illustrates a labeling user interface 422. In examples, the labeling user interface 422 may be presented to an administrator during a manual review process so that the administrator can review a case to determine if the case is legitimate or fraudulent. In the illustrated example, the labeling user interface 422 includes a video 1504 submitted with the case that the administrator is reviewing. In alternative embodiments, the labeling user interface 422 may include an image that was submitted with the case being reviewed.

Based on an analysis of the video 1504, the administrator may answer one or more questions 1506 about the video 1504. For example, in the illustrated example, the labeling user interface 422 includes a first question 1506a asking the administrator whether the quality of the video 1504 is satisfactory and a second question 1506b asking the administrator whether the video 1504 is genuine. The labeling user interface 422 further includes inputs 1508 through which the administrator may input responses to the questions 1506.

When the administrator has finished reviewing the case, the administrator may select an input 1510 to submit the review of the case. As described above, the response from the administrator may be used to train future authentication models. After submitting the review of the case, the labeling user interface 422 may be updated to present another case to be reviewed by the administrator.

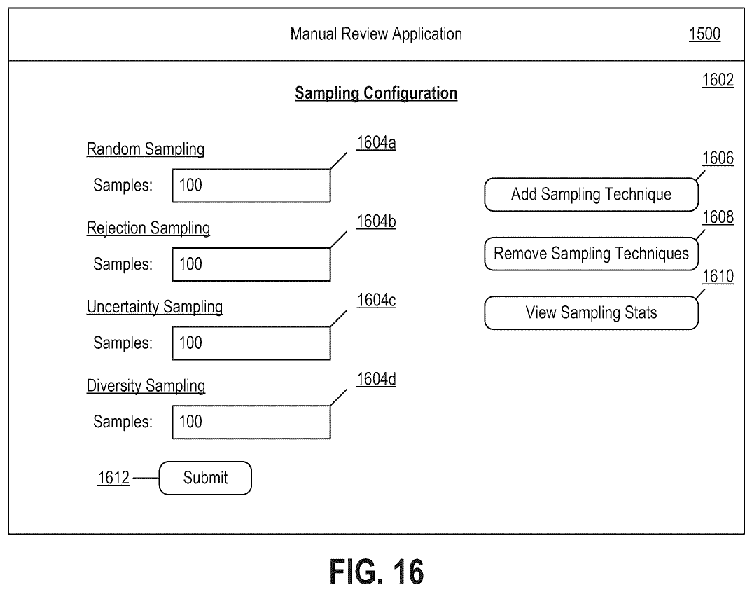

FIG. 16 illustrates a sampling configuration user interface 1602. In embodiments, the sampling techniques used to select samples for manual review may be configurable. The sampling configuration user interface 1602 may present options for an administrator to configure the sampling techniques used.

In the illustrated embodiment, the sampling configuration user interface 1602 includes options 1604 to set a number of samples collected by each sampling technique. In some embodiments, the administrator may set the defined number to be collected by each sampling technique. In other embodiments, the administrator may define the number of samples to be collected by the sampling techniques as a percentage of sampleable cases. For example, for random sampling, the input 1604a may be used to set the amount of samples collected as a percentage of total cases analyzed by an authentication model. In another example, for rejection sampling, the input 1604b may be used to set the amount of samples collected as a percentage of cases rejected by the authentication model.

In some embodiments, the authentication server may be configured to automatically configure the sampling techniques based on constraints set by the administrator and the performance of the sampling techniques. For example, the sampling techniques used and the number of samples collected by each sampling technique may be determined by the authentication server based on minimum and maximum amounts of samples that can be selected by each sampling technique defined by the administrator, throughput limits of the authentication server and the administrators performing the manual review process, and the performance of the sampling techniques.

In some embodiments, the sampling configuration user interface 1602 may allow the administrator to set minimum and maximum amounts of samples that can be selected by each sampling technique. The sampling configuration user interface 1602 may also include options for the administrator to define other constraints on the automatic configuration of the sampling techniques.

The sampling configuration user interface 1602 may also include an option 1606 to add a sampling technique and an option 1608 to remove sampling techniques. The sampling configuration user interface 1602 may also include an option 1610 to view sampling statistics. For example, as described further herein, the sampling statistics may allow the administrator to evaluate the performance of each sampling technique. The administrator may then configure the sampling techniques based on the performance of the sampling techniques. When the administrator is satisfied with the configuration of the sampling techniques, the administrator may select an option 1612 to submit the sampling configuration.

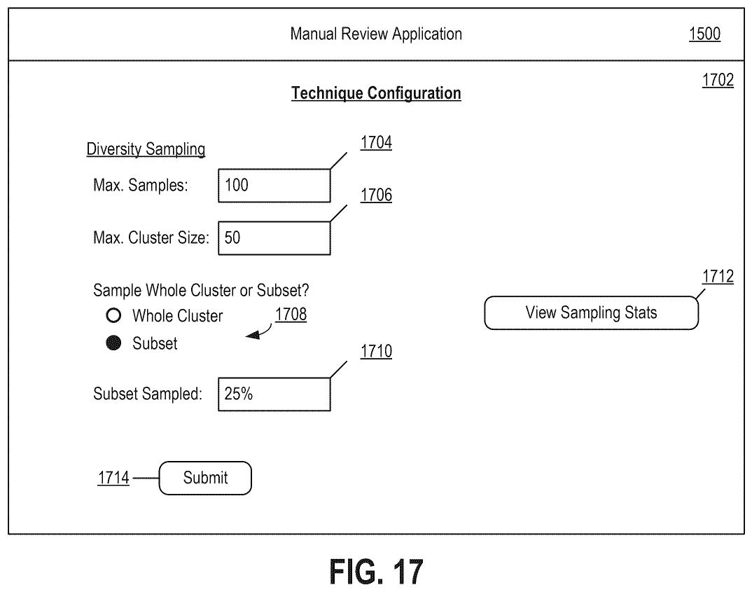

FIG. 17 illustrates an example technique configuration user interface 1702. In the illustrated example, the technique configuration user interface 1702 may be used to configure a diversity sampling technique. In alternative examples, the technique configuration user interface 1702 may be used to configure other sampling techniques, such as random sampling, rejection sampling, and uncertainty sampling.

The technique configuration user interface 1702 may include an input 1704 to define a maximum number of samples to be collected using the diversity sampling technique. The technique configuration user interface 1702 may also include options to define elements unique to a specific sampling technique—diversity sampling, in the illustrated example. In the illustrated example, the technique configuration user interface 1702 includes an option 1706 to define a maximum cluster size from which samples are selected. The technique configuration user interface 1702 also includes options 1708 to define whether the whole cluster is selected for sampling or a subset of the cluster and an option 1710 to define the size of the subset being sampled from the cluster.

The technique configuration user interface 1702 may also include an option 1712 to view sampling statistics. The sampling statistics may help the administrator determine how to configure the sampling technique. When the administrator is satisfied with the configuration of the sampling technique, the administrator may select an option 1714 to submit the technique configuration.

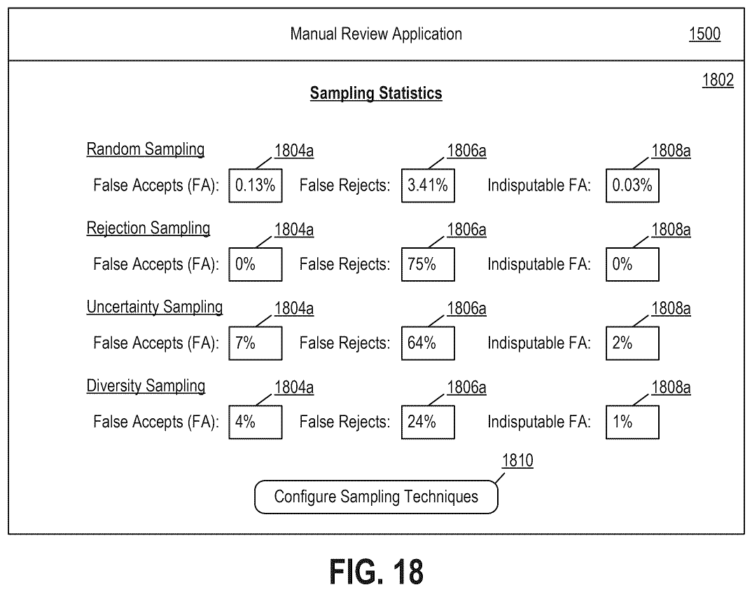

FIG. 18 illustrates an example sampling statistics user interface 1802. As described above, the sampling techniques used to select samples for manual review may be configurable. The sampling statistics user interface 1802 may provide statistics to help an administrator determine how to configure the sampling techniques for more efficient performance.

In embodiments, the sampling statistics user interface 1802 includes a plurality of statistics 1804, 1806, 1808 associated with each sampling technique. In the illustrated example, the sampling statistics user interface 1802 includes false accepts rates 1804, false rejects rates 1806, and indisputable false accepts rates 1808. The false accepts rates 1804 may indicate percentages of cases selected using the sampling techniques that were identified as legitimate by the authentication model and identified as fraud by the manual review. The false rejects rates 1806 may indicate percentages of cases selected using the sampling techniques that were identified as fraudulent by the authentication model and identified as legitimate by the manual review. The indisputable false accepts rates 1808 may indicate percentages of cases selected using the sampling techniques that were identified as legitimate by the authentication model and definitively confirmed to be fraudulent.

Based on the statistics 1804, 1806, 1808 shown in the sampling statistics user interface 1802, an administrator may choose to change a configuration of the sampling techniques. For example, if a sampling technique captures few false accepts and few false rejects, the administrator may choose to reduce the number of samples collected by the sampling technique, or the administrator may choose to stop using the sampling technique. Conversely, if a sampling technique captures many false accepts or many false rejects, the administrator may choose to increase the number of samples collected using the sampling technique. Similarly, as described above, the sampling configuration may automatically be set by the authentication server based on the sampling statistics 1804, 1806, 1808, as well as other constraints defined by the administrator. For example, the authentication server may configure the sampling techniques to maximize the false accepts rates and the false rejects rates while complying with the constraints defined by the administrator.

In the illustrated embodiment, the sampling statistics user interface 1802 includes an option 1810 to configure the sampling techniques. When the user selects that option 1810, the sampling configuration user interface 1602 described above may be presented to the user.

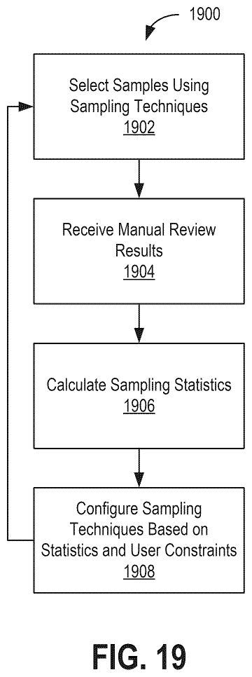

FIG. 19 illustrates a flowchart of an example method 1900 for configuring sampling techniques. In the illustrated example, the method 1900 includes operations 1902, 1904, 1906, 1908. In an example, the method 1900 may be performed by an authentication server.

The operation 1902 can include configuring one or more sampling techniques (e.g., to define how samples are selected by an individual sampling technique or across techniques) and further includes selecting samples using one or more sampling techniques. As described above, samples may be selected from production data using random sampling, rejection sampling, uncertainty sampling, and diversity sampling. In other examples, additional or alternative sampling techniques may be used to select samples. Labeling tasks may be created based on the sampled cases and provided to administrators for manual review.

The operation 1904 includes receiving results from the manual review process. For example, during the manual review process, administrators may indicate that cases are legitimate or fraudulent. In other embodiments, additional information may be collected during the manual review process. For example, the administrators may additionally indicate whether videos associated with the cases being reviewed have a satisfactory quality.

The operation 1906 includes calculating one or more sampling statistics. In examples, as described above, the sampling statistics may include a false accepts rate and a false rejects rate for each sampling technique. In other examples additional or alternative statistics may be calculated.

The operation 1908 includes configuring the sampling techniques based on the sampling statistics and one or more user constraints. For example, the user constraints may include a minimum and a maximum number of samples that can be collected by each sampling technique. Other constraints that may be considered include a throughput of the authentication server and a throughput of one or more manual reviewers. In an embodiment, the sampling techniques may be configured to maximize the false accepts rates and the false reject rates of the sampling techniques while complying with the constraints.

In alternative embodiments, an administrator may manually configure the sampling techniques. Inputs defining the sampling configuration may be received in these embodiments rather than performing the configuration.

After the sampling techniques are configured, the method 1900 may return to the operation 1902, and more samples may be collected using the newly configured sampling techniques. The method 1900 may loop for multiple iterations, allowing the sampling techniques to be further refined as new data is sampled.

In some embodiments, sampling techniques can be adaptively adjusted by evaluating the success rate of each method in identifying fraud and balancing their contributions to avoid over-reliance on any single approach. In some instances, a feedback loop can be used to update the weights of the sampling techniques based on an assessment of the outcomes of the current sampling strategies. For example, if cluster-based sampling identifies a higher proportion of fraudulent cases than random sampling, the weight applied to cluster-based sampling (e.g., in the sampling process) can be increased. In such examples, safeguards can be implemented to ensure that other techniques are not neglected entirely to maintain diversity.

To achieve this balance, a hybrid or ensemble approach can be used, where multiple sampling methods operate simultaneously, and their output is combined. A proportional allocation strategy could assign a fixed minimum sampling quota to less successful methods while prioritizing the most effective ones. Additionally, machine learning models can dynamically assess the performance of each technique and adjust sampling proportions in real time. This adaptive process ensures a robust and diversified sampling framework that captures a wide range of fraud patterns while staying responsive to emerging trends and changes in fraud behavior.

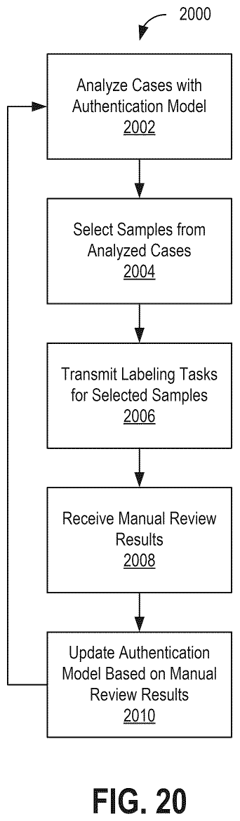

FIG. 20 illustrates a flowchart of an example method 2000 for training an authentication model. In the illustrated example, the method 2000 includes operations 2002, 2004, 2006, 2008, 2010. In an embodiment, the method 2000 may be performed by an authentication server.

The operation 2002 includes analyzing authentication cases with one or more authentication models. As described above, users may submit authentication requests to access a secure resource. The requests may include an image or a video of the user. The authentication model may analyze the image or video to determine if the user is who they claim to be. The authentication model may determine whether a case is legitimate or fraudulent, and if the case is legitimate, the authentication model may provide the user access to the secure resource. However, the authentication model may sometimes identify a legitimate case as fraudulent and a fraudulent case as legitimate.

The operation 2004 includes selecting samples from the analyzed cases for manual review. In an example, one or more configurable sampling techniques may be used to select the samples. In an embodiment, the sampling techniques may include random sampling, rejection sampling, uncertainty sampling, and diversity sampling. Labeling tasks may be created for each of the samples. For example, the labeling tasks may include the images or videos associated with the sampled cases and a request to indicate whether cases are legitimate or fraudulent.

The operation 2006 includes transmitting the labeling tasks to administrators for manual review. In examples, the administrators may analyze the cases associated with the labeling tasks and determine whether the cases are legitimate or fraudulent.

The operation 2008 includes receiving results from the manual review. Based on the manual review results, false accepts and false rejects may be identified. In an example, false accepts include cases that were determined to be legitimate by the authentication model and fraudulent by the administrator during the manual review, and false rejects include cases that were determined to be fraudulent by the authentication model and legitimate by the administrator during the manual review.

The operation 2010 includes updating the authentication model based on the manual review results. For example, the authentication model may be trained using the manually reviewed cases, allowing the authentication model to better identify fraudulent cases. In another example, a candidate authentication model may be trained using the manual review results. Based on an evaluation of the candidate authentication model, the candidate authentication model may be deployed in place of the original authentication model—e.g., if the candidate authentication model more accurately identifies fraudulent cases.

The method 2000 may loop as the authentication model is updated and new cases are analyzed. By repeatedly updating the authentication model, the authentication model can be better trained to identify fraudulent cases.

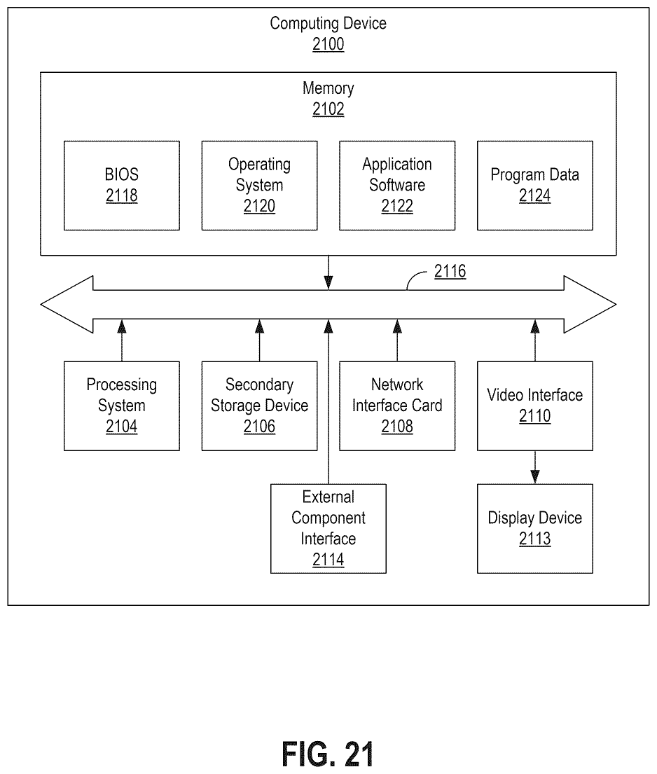

FIG. 21 illustrates an example computing device 2100 on which aspects of the present disclosure may be implemented. The computing device 2100 can be used, for example, to implement computing devices such as the computing device 30, the authentication server 20, or any other computing device usable as described above in connection with FIG. 1.

In the example of FIG. 21, the computing device 2100 includes a memory 2102, a processing system 2104, a secondary storage device 2106, a network interface card 2108, a video interface 2110, a display unit 2113, an external component interface 2114, and a communication medium 2116. The memory 2102 includes one or more computer storage media capable of storing data and/or instructions. In different embodiments, the memory 2102 is implemented in different ways. For example, the memory 2102 can be implemented using various types of computer storage media, and generally includes at least some tangible media. In some embodiments, the memory 2102 is implemented using entirely non-transitory media.

The processing system 2104 includes one or more processing units, or programmable circuits. A processing unit is a physical device or article of manufacture comprising one or more integrated circuits that selectively execute software instructions. In various embodiments, the processing system 2104 is implemented in various ways. For example, the processing system 2104 can be implemented as one or more physical or logical processing cores. In another example, the processing system 2104 can include one or more separate microprocessors. In yet another example embodiment, the processing system 2104 can include an application-specific integrated circuit (ASIC) that provides specific functionality. In yet another example, the processing system 2104 provides specific functionality by using an ASIC and by executing computer-executable instructions.

The secondary storage device 2106 includes one or more computer storage media. The secondary storage device 2106 stores data and software instructions not directly accessible by the processing system 2104. In other words, the processing system 2104 performs an I/O operation to retrieve data and/or software instructions from the secondary storage device 2106. In various embodiments, the secondary storage device 2106 includes various types of computer storage media. For example, the secondary storage device 2106 can include one or more magnetic disks, magnetic tape drives, optical discs, solid-state memory devices, and/or other types of tangible computer storage media.

The network interface card 2108 enables the computing device 2100 to send data to and receive data from a communication network. In different embodiments, the network interface card 2108 is implemented in different ways. For example, the network interface card 2108 can be implemented as an Ethernet interface, a fiber optic network interface, a wireless network interface (e.g., WiFi, WiMax, Bluetooth, etc.), or another type of network interface.

In optional embodiments where included in the computing device 2100, the video interface 2110 enables the computing device 2100 to output video information to the display unit 2113. The display unit 2113 can be various types of devices for displaying video information, such as an LCD display panel, a plasma screen display panel, a touch-sensitive display panel, an LED or OLED screen, a cathode-ray tube display, or a projector. The video interface 2110 can communicate with the display unit 2113 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 2114 enables the computing device 2100 to communicate with external devices. For example, the external component interface 2114 can be a USB interface and/or another type of interface that enables the computing device 2100 to communicate with external devices or peripheral devices integrated within the same housing (e.g., in the case of mobile devices). In various embodiments, the external component interface 2114 enables the computing device 2100 to communicate with various external components, such as external storage devices, input devices, speakers, modems, media player docks, other computing devices, scanners, digital cameras, and fingerprint readers.

The communication medium 2116 facilitates communication among the hardware components of the computing device 2100. The communication medium 2116 facilitates communication among the memory 2102, the processing system 2104, the secondary storage device 2106, the network interface card 2108, the video interface 2110, and the external component interface 2114. The communication medium 2116 can be implemented in various ways. For example, the communication medium 2116 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 2102 stores various types of data and/or software instructions. The memory 2102 stores a Basic Input/Output System (BIOS) 2118 and an operating system 2120. The BIOS 2118 includes a set of computer-executable instructions that, when executed by the processing system 2104, cause the computing device 2100 to boot up. The operating system 2120 includes a set of computer-executable instructions that, when executed by the processing system 2104, cause the computing device 2100 to provide an operating system that coordinates the activities and sharing of resources of the computing device 2100. Furthermore, the memory 2102 stores application software 2122. The application software 2122 includes computer-executable instructions, that when executed by the processing system 2104, cause the computing device 2100 to provide one or more applications. In an example, the memory 2102 stores application software 2122 for a manual review application. The memory 2102 also stores program data 2124. The program data 2124 is data used by programs that execute on the computing device 2100.

Although particular features are discussed herein as included within an electronic computing device 2100, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 2100 of FIG. 21, the computer-readable instructions are stored on devices that include non-transitory media. In particular embodiments, the computer-readable instructions are stored on entirely non-transitory media.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

The following is a non-exhaustive list of numbered examples which may or may not be claimed:

Example 1.1. A method for training a liveness authentication model to detect fraudulent authentication attempts in identity verification systems, the method comprising:
analyzing a plurality of authentication cases using a liveness authentication model;
selecting a plurality of samples from the plurality of authentication cases, the plurality of samples being selected using a plurality of configurable sampling techniques;
transmitting a plurality of labeling tasks to one or more administrators for manual review via a labeling user interface, each labeling task being associated with a sample of the plurality of samples;
receiving manual review results for the plurality of labeling tasks, wherein each manual review result indicates whether the associated sample is legitimate or fraudulent;
in response to identifying a sample as fraudulent during manual review, automatically labeling one or more additional samples proximate in embedding space to the fraudulent sample as fraudulent; and
updating the authentication model based on the manual review results and the one or more additional samples.

Example 1.2. The method of Example 1.1, wherein each authentication case includes biometric data submitted for identity verification and an authentication result indicating whether the biometric data corresponds to a live person.

Example 1.3. The method of any of Examples 1.1 or 1.2, wherein each labeling task includes a biometric image or video data from an associated sample.

Example 1.4. The method of any of Examples 1.1, 1.2, or 1.3, wherein each labeling task includes the authentication result from the liveness authentication model.

Example 1.5. The method of any of Examples 1.1, 1.2, 1.3, or 1.4, wherein each labeling task includes a request for binary classification as legitimate or fraudulent.

Example 1.6. The method of any of Examples 1.1, 1.2, 1.3, 1.4, or 1.5, wherein selecting the plurality of samples includes:
computing embeddings of image content in the authentication cases using a contrastive language-image pre-training model,
performing dimensionality reduction on the embeddings using uniform manifold approximation,
performing clustering on dimension-reduced embeddings using hierarchical density-based spatial clustering, and
selecting samples from clusters having sizes below a configurable threshold.

Example 1.7. The method of any of Examples 1.1, 1.2, 1.3, 1.4, or 1.5, wherein updating the authentication model includes:
training a candidate liveness authentication model using the manual review results from the plurality of samples and the one or more additional samples; and
and deploying the candidate liveness authentication model.

Example 1.8. The method of any of Examples 1.1, 1.2, 1.3, 1.4, or 1.5, wherein updating the authentication model includes:
calculating one or more sampling statistics comprising false accept rates and false reject rates for each of the plurality of sampling techniques; and
automatically modifying configurations of the plurality of sampling techniques based on the sampling statistics to maximize fraud detection rates while complying with defined throughput constraints.

Example 1.9. The method of any of Examples 1.1, 1.2, 1.3, 1.4, 1.5, 1.6, 1.7, or 1.8, wherein the one or more additional samples proximate in embedding space to the fraudulent sample are determined by calculating Euclidean distances in the embedding space and selecting samples within a predetermined distance threshold from each identified fraudulent sample.

Example 1.10. The method of Example 1.9, wherein the predetermined distance threshold for cluster size is configurable.

Example 1.11. The method of any of Examples 1.1, 1.2, 1.3, 1.4, 1.5, 1.6, 1.7, 1.8, 1.9, or 1.10, wherein the plurality of sampling techniques are configurable through a sampling configuration user interface that allows an administrator to define minimum and maximum sample amounts for each sampling technique.

Example 1.12. The method of any of Examples 1.1, 1.2, 1.3, 1.4, 1.5, 1.6, 1.7, 1.8, 1.9, 1.10, or 1.11, wherein the liveness authentication model detects whether biometric data depicts a live person present during authentication or a photograph, mask, or three-dimensional representation of a person.

Example 1.13. The method of any of Examples 1.1, 1.2, 1.3, 1.4, 1.5, 1.6, 1.7, 1.8, 1.9, 1.10. 1.11, or 1.12, wherein the plurality of sampling techniques includes uncertainty sampling comprising furthest score disagreement sampling that selects authentication cases where a difference between authentication scores from multiple authentication models exceeds a predetermined difference threshold.

Examples 1.1-1.13 may provide a technically robust and adaptive framework for training liveness authentication models by integrating multiple configurable sampling techniques (e.g., diversity sampling via CLIP-generated embeddings, UMAP dimensionality reduction, and HDBSCAN clustering) to efficiently identify rare and emerging fraud patterns. Examples further enhance detection accuracy through an iterative sampling mechanism that automatically expands the training dataset based on embedding-space proximity to manually identified fraudulent cases. By incorporating real-time performance metrics such as false accept and reject rates, examples dynamically reconfigure sampling strategies to optimize fraud detection while maintaining operational efficiency, delivering a self-improving, scalable solution for high-volume biometric authentication environments.

1. A method for training an identity verification authentication model configured to detect fraudulent authentication attempts from biometric data, the method comprising:
analyzing a plurality of authentication cases using an authentication model, wherein each authentication case comprises biometric content captured during an identity verification attempt;
selecting a plurality of samples from the plurality of authentication cases, the plurality of samples being selected using a plurality of sampling techniques;
transmitting a plurality of labeling tasks to one or more administrators for manual review, each labeling task associated with a sample of the plurality of samples;
receiving manual review results for the plurality of labeling tasks, wherein each manual review result indicates whether the associated sample is legitimate or fraudulent;
identifying, based on the manual review results, one or more cluster patterns in an embedding space, wherein authentication cases corresponding to known fraudulent attempts form fraudulent clusters and authentication cases corresponding to legitimate attempts form legitimate clusters; and
updating the authentication model based on the manual review results and the identified cluster patterns to improve detection of both known fraud patterns within existing clusters and emerging fraud patterns represented by outlier cases distant from known fraudulent clusters.

2. The method of claim 1, wherein the plurality of sampling techniques includes one or more of random sampling, rejection sampling, uncertainty sampling, or diversity sampling configured to identify underrepresented fraud patterns in the embedding space by selecting samples from clusters having sizes below a predetermined threshold.

3. The method of claim 2, wherein the biometric content includes image content submitted by a user, the image content being at least one of video or image data, the method further comprising:
computing embeddings of the image content for each of the plurality of samples; and
joining the embeddings into a matrix, wherein proximity of embeddings in the matrix indicates similarity between authentication attempts, enabling identification of fraud rings and coordinated attack patterns.

4. The method of claim 3, further comprising performing dimension reduction on the matrix using uniform manifold approximation and projection (UMAP).

5. The method of claim 4, wherein the plurality of sampling techniques includes diversity sampling, the method further including:
performing clustering on the dimension-reduced matrix using hierarchical density-based spatial clustering of applications with noise (HDBSCAN) to group authentication cases; and
selecting samples based on the clustering.

6. The method of claim 5, wherein selecting samples based on the clustering includes:
determining a size for each cluster; and
selecting the samples from each cluster having a size less than a predetermined threshold.

7. The method of claim 3, wherein the embeddings are computed using a contrastive language-image pre-training (CLIP) model.

8. The method of claim 2, wherein uncertainty sampling includes selecting, for inclusion in the plurality of samples, an authentication case in which an authentication score computed by the authentication model is less than a predetermined distance from a decision boundary.

9. The method of claim 2, wherein uncertainty sampling includes selecting, for inclusion in the plurality of samples, an authentication case in which a difference between a first authentication score computed by the authentication model and a second authentication score computed by a second authentication model is greater than a predetermined difference.

10. The method of claim 2, wherein uncertainty sampling includes selecting, for inclusion in the plurality of samples, an authentication case in which an authentication result determined by the authentication model is different than a second authentication result determined by a second authentication model.

11. The method of claim 2, wherein rejection sampling includes selecting an authentication case in which an authentication result determined by the authentication model indicates that the authentication case is fraudulent.

12. The method of claim 1, wherein updating the authentication model based on the manual review results and the identified cluster patterns includes:
training a candidate authentication model based on the manual review results;
evaluating the candidate authentication model; and
based on the evaluation of the candidate authentication model, deploying the candidate authentication model in place of the authentication model.

13. The method of claim 1, wherein the plurality of sampling techniques is configurable by a user in a user interface.

14. The method of claim 1, further comprising:
based on the manual review results, selecting one or more additional samples from the plurality of authentication cases.

15. A system for automating sampling of authentication case data in an identity verification system, the automated system comprising:
a processing unit;
a memory storing instructions which, when executed, cause the automated system to perform:
receiving a dataset comprising (1) biometric data previously submitted to an identity verification system for analysis at an authentication model during an identity verification attempt and (2) results of the analysis at the authentication model;
analyzing the dataset to identify a plurality of samples using a plurality of sampling techniques;
identifying, based on manual review of the plurality of samples, one or more cluster patterns in an embedding space, wherein authentication cases corresponding to known fraudulent attempts form fraudulent clusters and authentication cases corresponding to legitimate attempts form legitimate clusters;
in response to identifying the one or more cluster patterns, automatically identifying one or more additional samples from among the dataset, the one or more additional samples being proximate in the embedding space to a sample associated with a fraudulent cluster; and
training an updated authentication model based, at least in part, on the manual review of the plurality of samples, the one or more cluster patterns, and the one or more additional samples to improve detection of both known fraud patterns within existing clusters and emerging fraud patterns represented by outlier cases distant from known fraudulent cluster.

16. The method of claim 15, wherein the plurality of sampling techniques includes one or more of random sampling, rejection sampling, uncertainty sampling, or diversity sampling.

17. The method of claim 15, wherein selecting the one or more additional samples from the plurality of authentication cases includes:
receiving an identification of a sample as fraudulent during the manual review; and
selecting the one or more additional samples based on the identified sample using a nearest neighbor algorithm using embeddings of the plurality of samples.

18. The method of claim 17, wherein each sample includes biometric data submitted by a user attempting authentication, the biometric data including at least one of video or image data, and wherein selecting the one or more additional samples based on the identified sample using a nearest neighbor algorithm includes:
computing embeddings of the biometric data associated with the plurality of authentication cases,
wherein the nearest neighbor algorithm selects the one or more additional samples using the embeddings associated with the one or more additional samples and the embeddings associated with the identified sample.

19. A method for configuring sampling techniques for selecting samples for training an authentication model configured to detect fraudulent authentication attempts from biometric data, the method comprising:
receiving configuration information defining a configuration of each of a plurality of sampling techniques;
analyzing a plurality of authentication cases using an authentication model, wherein each authentication case comprises biometric content captured during an identity verification attempt;
selecting a plurality of samples from the plurality of authentication cases using the plurality of sampling techniques, wherein a number of samples collected by each of the plurality of sampling techniques is defined by the configuration information;
transmitting a plurality of labeling tasks to one or more administrators for manual review, each labeling task associated with a sample of the plurality of samples;
receiving manual review results for the plurality of labeling tasks, wherein each manual review result indicates whether the associated sample is legitimate or fraudulent;
calculating one or more sampling statistics for each of the one or more sampling techniques; and
based on the sampling statistics and one or more defined restraints, modifying the configuration information of at least one sampling technique from among the plurality of sampling techniques.

20. The method of claim 19, wherein the plurality of sampling techniques includes one or more of random sampling, rejection sampling, uncertainty sampling, or diversity sampling, and
wherein the defined restraints include minimum numbers of samples that can be collected using each sampling technique and maximum numbers of samples that can be collected using each sampling technique.
